(19) United States
(12) Patent Application Publication
(10) Pub. No.: US 2025/0258150 A1
(43) Pub. Date: Aug. 14, 2025

(54) SYSTEMS AND METHODS FOR ANALYSIS OF DATA INDEPENDENT ACQUISITION (DIA) DATA

(71) Applicants: Thermo Fisher Scientific (Bremen) GmbH, Bremen (DE); Thermo Electron Sweden Forvaltning AB, Stockholm (SE)

(72) Inventors: Christoph Henrich, Bremen (DE); Robert Malek, Lilienthal (DE); Katja Tham, Linköping (SE); Kai Fritzemeier, Stuhr (DE)

(21) Appl. No.: 19/046,799

(22) Filed: Feb. 6, 2025

Related U.S. Application Data
(60) Provisional application No. 63/551,272, filed on Feb. 8, 2024.

(51) Int. Cl. G01N 30/86; G01N 30/72; G06T 11/20

(52) U.S. Cl. CPC G01N 30/8679; G01N 30/7233; G06T 11/206

(57) ABSTRACT

A computer-implemented method, for improving data analysis and data storage processes, can comprise identifying, by a system operatively coupled to a processor, a cluster of chromatographic peaks, corresponding to fragment ions, of initial measurement data obtained by data independent acquisition, and generating, by the system, a condensed spectrum comprising one or more condensed spectrographic peaks each having an intensity value and a mass value that are based on characteristic values aggregated from the cluster of chromatographic peaks.

### CROSS-REFERENCE TO RELATED APPLICATIONS

This application claims priority to and the benefit of U.S. Provisional Application No. 63/551,272, entitled “SYSTEM AND METHODS FOR ANALYSIS OF DATA INDEPENDENT ACQUISITION (DIA) DATA,” which was filed on Feb. 8, 2024. The entirety of the aforementioned application is hereby incorporated herein by reference.

### BACKGROUND

Mass spectrometry is a technique for detecting, identifying, and quantifying molecules within analytes based on their molecular mass-to-charge ratio after ionization. Data generated by mass spectrometry operations can be used in proteomics and other scientific applications. Analysis of mass spectrometry data can be a complicated endeavor due to a volume of such data. This can be the case regardless of whether data independent acquisition (DIA) or data dependent acquisition (DDA) processes are employed.

Chromatography is a method to separate analytes in space and/or time. In the context of mass spectrometry, gas chromatography and liquid chromatography, preferably high performance liquid chromatography, are of high relevance. Components of analytes are separated in time and the eluent from the chromatograph is then analysed by the mass spectrometer.

### SUMMARY

The following presents a summary to provide a basic understanding of one or more example embodiments described herein. This summary is not intended to identify key or critical elements, and/or to delineate scope of particular embodiments or scope of claims. Its sole purpose is to present concepts in a simplified form as a prelude to the more detailed description that is presented later. In one or more example embodiments, systems, computer-implemented methods, apparatuses and/or computer program products described herein can provide a plug-and-play process for using chromatographic trace data generated by a measurement instrument (also herein referred to as a measurement device) to transform data acquired by a data independent acquisition process (DIA) by a mass spectrometry instrument into data than can be analyzed using data dependent acquisition (DDA) processes.

In accordance with an embodiment, a system can comprise a memory that stores computer executable components, and a processor that executes the computer executable components. The computer executable components can comprise an identifying component that identifies a cluster of chromatographic peaks, corresponding to fragment ions, of initial measurement data obtained by data independent acquisition, and a condensed spectrum generating component that generates a condensed spectrum comprising one or more condensed spectrographic peaks each having an intensity value and a mass value that are based on characteristic values aggregated from the cluster of chromatographic peaks.

In accordance with another embodiment, a computer-implemented method can comprise identifying, by a system operatively coupled to a processor, a cluster of chromatographic peaks, corresponding to fragment ions, of initial measurement data obtained by data independent acquisition, and generating, by the system, a condensed spectrum comprising one or more condensed spectrographic peaks each having an intensity value and a mass value that are based on characteristic values aggregated from the cluster of chromatographic peaks.

In accordance with another embodiment, a computer program product, facilitating a process for improving data analysis and data storage processes, can comprise a computer readable storage medium having program instructions embodied therewith. The program instructions can be executable by a processor to cause the processor to identify, by the processor, a cluster of chromatographic peaks, corresponding to fragment ions, of initial measurement data obtained by data independent acquisition, and generate, by the processor, a condensed spectrum comprising one or more condensed spectrographic peaks each having an intensity value and a mass value that are based on characteristic values aggregated from the cluster of chromatographic peaks.

The one or more example embodiments described herein can be implemented within, in connection with and/or coupled to a chemical structure measurement instrument, such as a scientific measurement instrument, such as a spectrometry instrument.

The one or more example embodiments described herein can be employed to generate data comprising less complex information, as compared to the original data acquired by data independent acquisition (e.g., DIA data). The generated data can be analyzed with less identification power and/or bandwidth being used, as compared to analysis of the original data acquired by data independent acquisition processes. That is, the data generated can be defined as condensed data, being based on the data acquired by data independent acquisition (e.g., DIA data), but analyzable using methods usually used for data dependent acquisition (DDA) processes. Put another way, the one or more example embodiments described herein can normalize DIA data for DDA and/or DDA-like methods. As used herein, DDA-like methods can comprise processes used in existing DDA methods, but employ condensed data as described herein.

One or more additional benefits of the one or more embodiments described herein can comprise consolidation of data (in the sense that information from multiple (raw) spectra in a vicinity (i.e. within a time or spectrum number range) is considered to generate improved data which may exclude noise, use information from multiple signals to generate data with improved properties regarding e.g. mass, intensity/area, retention time, or include signals that might be suppressed by prior art data compression or data analysis methods) and associated reduction in storage space.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings.

FIG. 1 illustrates a block diagram of an example data analysis module for performing data analysis operations, in accordance with one or more example embodiments described herein.

FIG. 2 illustrates a flow diagram of an example method of performing data analysis operations, in accordance with one or more example embodiments described herein.

FIG. 3 illustrates an example of a graphical user interface that can be used in the performance of some or all of the data analysis methods disclosed herein, in accordance with one or more example embodiments described herein.

FIG. 4 illustrates a block diagram of an example computing device that can perform some or all of the data analysis methods disclosed herein, in accordance with one or more example embodiments described herein.

FIG. 5 illustrates a block diagram of an example data analysis system in which some or all of the data analysis methods disclosed herein may be performed, in accordance with one or more example embodiments described herein.

FIG. 6 illustrates a block diagram of an example non-limiting system, in accordance with one or more example embodiments described herein.

FIG. 7 provides an illustration of an MS2 space that can be generated employing a spectrometry instrument for use by the non-limiting system of FIG. 6, in accordance with one or more example embodiments described herein.

FIG. 8 provides another illustration of the MS2 space of FIG. 8, with a retention time slice identified for analysis and condensed data generation by the non-limiting system of FIG. 6, in accordance with one or more example embodiments described herein.

FIG. 9 illustrates a schematic diagram of one or more process that can be performed by the non-limiting system of FIG. 6 to generate a condensed spectrum, in accordance with one or more example embodiments described herein.

FIG. 10 illustrates a set of example scenarios for storage of condensed data, such as condensed data, that can be performed by the non-limiting system of FIG. 6, in accordance with one or more example embodiments described herein.

FIG. 11 illustrates a set of example scenarios for generation of condensed data, such as condensed data, that can be performed by the non-limiting system of FIG. 6, in accordance with one or more example embodiments described herein.

FIG. 12 illustrates another set of example scenarios for generation of condensed data, such as condensed data, that can be performed by the non-limiting system of FIG. 6, in accordance with one or more example embodiments described herein.

FIG. 13 illustrates still another set of example scenarios for generation of condensed data, such as condensed data, that can be performed by the non-limiting system of FIG. 6, in accordance with one or more example embodiments described herein.

FIG. 14 illustrates a flow diagram of one or more processes that can be performed by the non-limiting system of FIG. 6, in accordance with one or more example embodiments described herein.

FIG. 15 illustrates a continuation of the flow diagram of FIG. 14 of one or more processes that can be performed by the non-limiting system of FIG. 6, in accordance with one or more example embodiments described herein.

FIG. 16 illustrates a block diagram of an example operating environment into which embodiments of the subject matter described herein can be incorporated.

FIG. 17 illustrates an example schematic block diagram of a computing environment with which the subject matter described herein can interact and/or be implemented at least in part.

FIG. 18 illustrates guided image detection that can be performed by the non-limiting system of FIG. 6, in accordance with one or more example embodiments described herein.

FIG. 19 illustrates still additional guided image detection for a single cluster of data that can be performed by the non-limiting system of FIG. 6, in accordance with one or more example embodiments described herein.

FIG. 20 illustrates guided image detection comprising association of data guided by the data being parallel to the mass axis, which can be performed by the non-limiting system of FIG. 6, in accordance with one or more example embodiments described herein.

FIG. 21 illustrates intensity curves that can be used for determination of a time centroid relative to the guided image detection of FIG. 20, and which can be performed by the non-limiting system of FIG. 6, in accordance with one or more example embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section.

Turning first to the subject of chemical structure measurement instruments generally, such measurement instruments can comprise, but are not limited to spectrometry devices, chromatography devices, etc. Output from such devices can comprise measurement data defining intensities, mass-to-charge ratios, analyte conductivities, precursors and/or analytes analyzed during analysis.

One such type of measurement data can be chromatography data resulting from operation of a chromatography device. Chromatography is an analytical technique used for separating molecules of analytes in a mixture. In liquid chromatography, a particular type of chromatography, one or more analytes can be identified based on a time the analytes exit a separator/column, referred to as retention time and/or elution time.

That is, in the chromatographic process, the analytes travel through a column propelled by a mobile phase while interacting with a stationary phase. Separation is accomplished due to the differing affinities of the analytes for the stationary phase vs. the mobile phase. As the analytes exit the column, their presence is captured by a detector placed downstream from the column, the resulting trace is the chromatogram or chromatographic trace. An analyte's retention time is specific to a nature of the analyte, hence its use for identification.

In correspondence therewith, a maximum mass/charge (m/z) value for an eluted compound, such as a peptide, can correspond to an elution time for that compound. An amount of such compound can be equal to an area under a chromatographic trace corresponding to that compound.

Another type of measurement data can be spectrometry data resulting from operation of a spectrometry device, such as based on analysis (e.g., fragmentation) of one or more compounds eluted from a chromatography operation.

In one or more cases, spectrometry data can be acquired using data independent acquisition (DIA). DIA comprises the use of a full scan of a multiple precursors being analyzed in parallel with one another. That is, DIA employs fragmentation of all analyte ions in an analyte, for which corresponding mass-to-charge (m/z) ratios are generated. In addition, data can be generated for a plurality of frequency windows in parallel with one another. Data generated can thereafter be binned, such as based on a set of different m/z ranges, where the bins of data can be separately analyzed. In general, use of DIA results in a large quantity of data (e.g., exhaustive datasets) based on fragments of all compounds within an analyte.

One or more benefits of DIA, as compared to data dependent acquisition (DDA), to be described below, can comprise allowing for use with complex analytes. The exhaustive data can allow for increased specificity during analysis, such as to differentiate between ions with same m/z ratios but different sequences by using fragment ions to distinguish between multiple precursor ions fragmented simultaneously. Additionally, in view of the exhaustive data, DIA can be more reproducible than DDA, ensuring consistent coverage over a specified m/z range.

One example use, among various others, for DIA is for characterizing different between biological systems in quantitative proteomics.

Put another way, using DIA, it can be possible to cover a complete mass range with isolation windows for fragmentation of the thus selected precursors and still receive meaningful fragmentation spectra. The interpretation of these DIA data can present a challenge because isolation windows are wide, and precursor ions can be unknown. For example, if one does not make a decision based on the precursor ion spectrum and does not isolate a specific precursor ion, it can be questioned why to acquire the MS¹ spectra at all, thereby eroding away time that could be used for more fragment spectra.

In one or more other cases, spectrometry data can be acquired using data dependent acquisition (DDA). DDA comprises selection aspects relative to DIA. For example, DDA can comprise selection of one or more specific ions, compounds and/or precursors to fragment, such as based on their intensity and/or abundance in the overall analyte. For example, this process can comprise performing fragmentation of the top N peaks seen in a spectrum acquired without fragmentation, or performing precursor isolation and fragmentation in response to observation of a mass from a user specified list (optionally at a user specified retention time). This process can be completed in multiple batches, such as until a sufficient number of peptides have been unequivocally identified and/or quantified. As compared to DIA, which can be described as methodical and/or impartial, DDA can be described as selective.

DDA can be limited to generation of incomplete or biased data, as compared to exhaustive and/or non-partial DIA data. One or more benefits of DDA, as compared to DIA, can comprise use for less complex analytes requiring less identification power and/or bandwidth. For example, DDA can be useful for small scale studies for which high sensitivity and/or accuracy is desired. As a result, simpler data can be analyzed using less complex approaches, but with lesser depth of insights.

Put another way, data dependent analysis has been historically employed when instruments started to be controlled by computers that had the resources to evaluate the MS¹-spectra and select precursor masses based on criteria set up by the user entity or by the instrument manufacturer. These criteria can be relative intensity (i.e., perform fragmentation of the top N peaks seen in a spectrum acquired without fragmentation, or perform (precursor isolation and) fragmentation in response to observation of a mass from a user specified list, optionally at a user specified retention time, etc.)

Data dependent acquisition brought progress to the field of scientific measurement, as historically, instruments were slow compared with existing instruments and decisions had to be made to use instrument time in the best possible way.

Now that mass spectrometry instruments have become faster and faster,] disadvantages of just data dependent acquisition have gained more visibility. That is, the decision process may produce different choices regarding which precursors to select and fragment.

A benefit of DDA is that the precursor ion is known as a result of the decision process. The isolation window is often tailored to the precursor mass and the fragmentation spectra contain fragments in a best case of only one precursor mass or fragments of very few precursor masses, which can be identified in the spectrum that was used for decision making.

Accordingly, both DIA and DDA analyses have their respective benefits and deficiencies.

To account for one or more of these deficiencies, the one or more embodiments described herein can provide a process for employing DDA-like data analysis (e.g., less complex and more specific analysis) based on rapidly and impartially obtained DIA data.

As used herein, the term “analyte” can refer to a compound comprising one or more ions, which analyte can be eluted from a precursor using chromatography techniques performed by a chromatography instrument.

As used herein, the phrase “based on” should be understood to mean “based at least in part on,” unless otherwise specified.

As used herein, the term “compound” can refer to a single material, multiple materials, composition, sample, analyte, solution, product, etc.

As used herein, the term “data” can comprise metadata.

As used herein, the terms “entity,” “requesting entity,” and “user entity” can refer to a machine, instrument, device, component, hardware, software, smart device, party, organization, individual and/or human.

One or more example embodiments are now described with reference to the drawings, where like referenced numerals are used to refer to like drawing elements throughout. In the following description, for purposes of explanation, numerous specific details are set forth in order to provide a more thorough understanding of the one or more example embodiments. It is evident in various cases, however, that the one or more example embodiments can be practiced without these specific details.

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein.

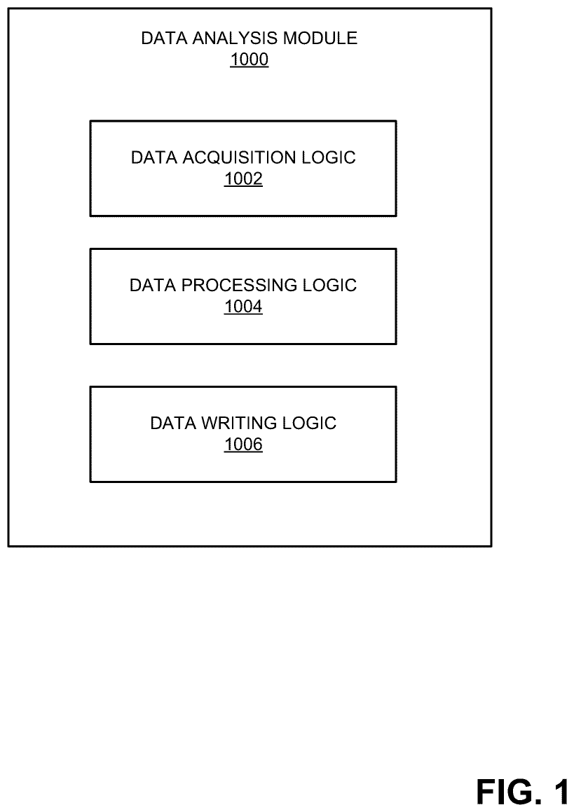

Referring now first to FIGS. 1 to 5, disclosed are one or more mass spectrometry data analysis systems, as well as related methods, computing devices, and computer-readable media. For example, in some embodiments, data independent acquisition (DIA) data generated by a mass spectrometer can be processed to generate spectral data that can be analyzed like data from data dependent acquisition (DDA) experiments.

The embodiments disclosed herein can achieve better performance relative to conventional approaches. For example, some conventional DIA data processing workflows are slow, limiting the rate at which scientific results can be observed. Further, as mass spectrometry instruments become more powerful and sensitive, the rate at which they generate data increases, as does the processing time. Additionally, storage of large mass spectrometry data sets raises challenges that may not be met by conventional data storage techniques.

Various ones of the embodiments disclosed herein can improve upon conventional approaches to achieve the technical advantages of faster data processing and/or reduced data storage requirements for large mass spectrometry data sets. For example, various ones of the embodiments disclosed herein can result in improvements in analysis speed, improved usage of retention time (RT) prediction tools, robustness against mass shifts based on intensity, data reduction without information loss, and instrument capabilities.

It is noted that the method should not be considered lossless in the usual sense. The goals can be similar to those of Moving Picture Experts Group (MPEG) audio layer 3 (MP3) compression, e.g., information can be selected or discarded based on what is (e.g., with high probability) going to be perceived or ignored by downstream processing.

Such technical advantages are not achievable by routine and conventional approaches, and all users of systems including such embodiments can benefit from these advantages (e.g., by assisting the user in the performance of a technical task, such as mass spectrometry data analysis). The technical features of the embodiments disclosed herein are thus decidedly unconventional in the field of mass spectrometry computational techniques, as are the combinations of the features of the embodiments disclosed herein. As discussed further herein, various aspects of the embodiments disclosed herein can improve the functionality of a computer itself; for example, any one or more computers that process data generated by a mass spectrometer. The computational and user interface features disclosed herein do not only involve the collection and comparison of information but apply new analytical and technical techniques to change the operation of mass spectrometry systems. The present disclosure thus introduces functionality that neither a conventional computing device, nor a human, could perform.

Accordingly, the embodiments of the present disclosure can serve any of a number of technical purposes, such as controlling a specific technical system (e.g., a mass spectrometry system); mass spectrometry data analysis; encoding data for reliable and/or efficient storage; determining properties of an analyte by processing data obtained from a mass spectrometer; or providing a faster processing of mass spectrometry data. In particular, the present disclosure provides technical solutions to technical problems, including but not limited to mass spectrometry data analysis and/or storage.

The embodiments disclosed herein thus provide improvements to analytical instrument technology (e.g., improvements in the computer technology supporting mass spectrometers, among other improvements).

In the following detailed description, reference is made to the accompanying drawings that form a part hereof wherein like numerals designate like parts throughout, and in which is shown, by way of illustration, embodiments that can be practiced. It is to be understood that other embodiments can be utilized, and structural or logical changes can be made, without departing from the scope of the present disclosure. Therefore, the following detailed description is not to be taken in a limiting sense.

Various operations can be described as multiple discrete actions or operations in turn, in a manner that is most helpful in understanding the subject matter disclosed herein. However, the order of description should not be construed as to imply that these operations are necessarily order dependent. In particular, these operations may not be performed in the order of presentation. Operations described can be performed in a different order from the described embodiment. Various additional operations can be performed, and/or described operations can be omitted in additional embodiments.

For the purposes of the present disclosure, the phrases “A and/or B” and “A or B” mean (A), (B), or (A and B). For the purposes of the present disclosure, the phrases “A, B, and/or C” and “A, B, or C” mean (A), (B), (C), (A and B), (A and C), (Band C), or (A, B, and C). Although some elements can be referred to in the singular (e.g., “a processing device”), any appropriate elements can be represented by multiple instances of that element, and vice versa. For example, a set of operations described as performed by a processing device can be implemented with different ones of the operations performed by different processing devices. As used herein, the phrase “based on” should be understood to mean “based at least in part on,” unless otherwise specified.

The description uses the phrases “an embodiment,” “various embodiments,” and “some embodiments,” each of which can refer to one or more of the same or different embodiments. Furthermore, the terms “comprising,” “including,” “having,” and the like, as used with respect to embodiments of the present disclosure, are synonymous. When used to describe a range of dimensions, the phrase “between X and Y” represents a range that includes X and Y. As used herein, an “apparatus” can refer to any individual device, collection of devices, part of a device, or collections of parts of devices. The drawings are not necessarily to scale.

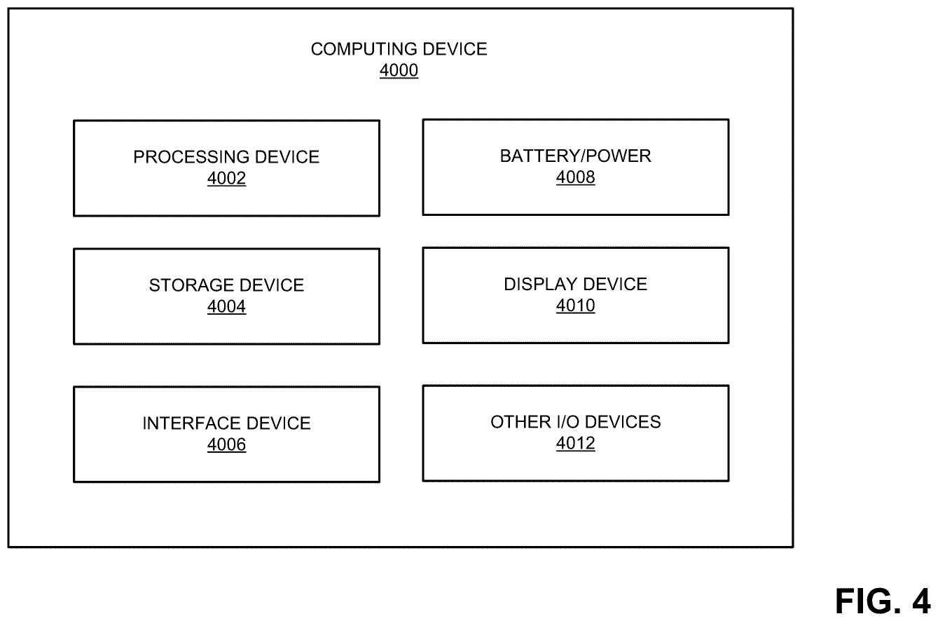

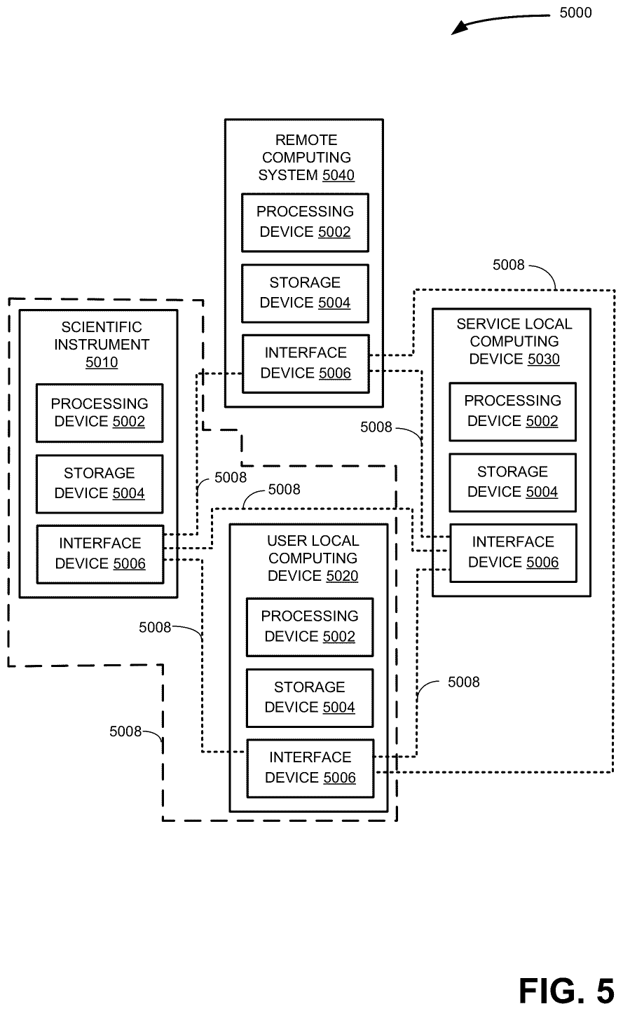

FIG. 1 is a block diagram of a data analysis module 1000 for performing data analysis operations, in accordance with various embodiments. The data analysis module 1000 can be implemented by circuitry (e.g., including electrical and/or optical components), such as a programmed computing device. The logic of the data analysis module 1000 can be included in a single computing device or can be distributed across multiple computing devices that are in communication with each other as appropriate. Examples of computing devices that can, singly or in combination, implement the data analysis module 1000 are discussed herein with reference to the computing device 4000 of FIG. 4, and examples of systems of interconnected computing devices, in which the data analysis module 1000 can be implemented across one or more of the computing devices, is discussed herein with reference to the data analysis system 5000 of FIG. 5.

The data analysis module 1000 can include data acquisition logic 1002, data processing logic 1004, and data writing logic 1006. As used herein, the term “logic” can include an apparatus that is to perform a set of operations associated with the logic. For example, any of the logic elements included in the data analysis module 1000 can be implemented by one or more computing devices programmed with instructions to cause one or more processing devices of the computing devices to perform the associated set of operations. In a particular embodiment, a logic element can include one or more non-transitory computer-readable media having instructions thereon that, when executed by one or more processing devices of one or more computing devices, cause the one or more computing devices to perform the associated set of operations. As used herein, the term “module” can refer to a collection of one or more logic elements that, together, perform a function associated with the module. Different ones of the logic elements in a module can take the same form or can take different forms. For example, some logic in a module can be implemented by a programmed general-purpose processing device, while other logic in a module can be implemented by an application-specific integrated circuit (ASIC) and/or graphics processing unit (GPU). In one or more cases, a GPU can be employed when processing is using image processing algorithm and/or an analytical model (e.g., an artificial intelligence model, convoluted neural network model, deep neural network model, machine learning model, etc.) In another example, different ones of the logic elements in a module can be associated with different sets of instructions executed by one or more processing devices. A module may not include all of the logic elements depicted in the associated drawing; for example, a module can include a subset of the logic elements depicted in the associated drawing when that module is to perform a subset of the operations discussed herein with reference to that module.

The data acquisition logic 1002 can trigger the acquisition of data about an analyte by a mass spectrometer, and/or can receive data from the mass spectrometer after the mass spectrometer has acquired data about an analyte. The data can be data independent acquisition (DIA) data. In some embodiments, the data acquisition logic 1002 can instruct a mass spectrometer to use a DIA mode to acquire data about the analyte, where DIA mode is one of several modes of data acquisition (including data dependent acquisition or DDA mode), as known in the art.

The data processing logic 1004 can process the data generated by the mass spectrometer about an analyte.

The data writing logic 1006 can write the processed data to a data storage location or into a data stream for transmission to another computing device or instrument.

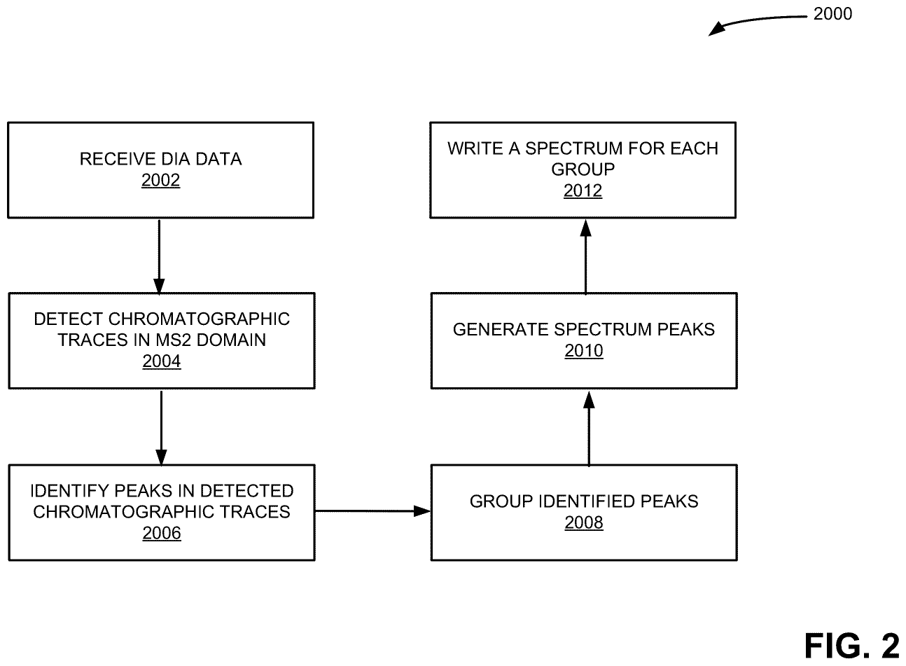

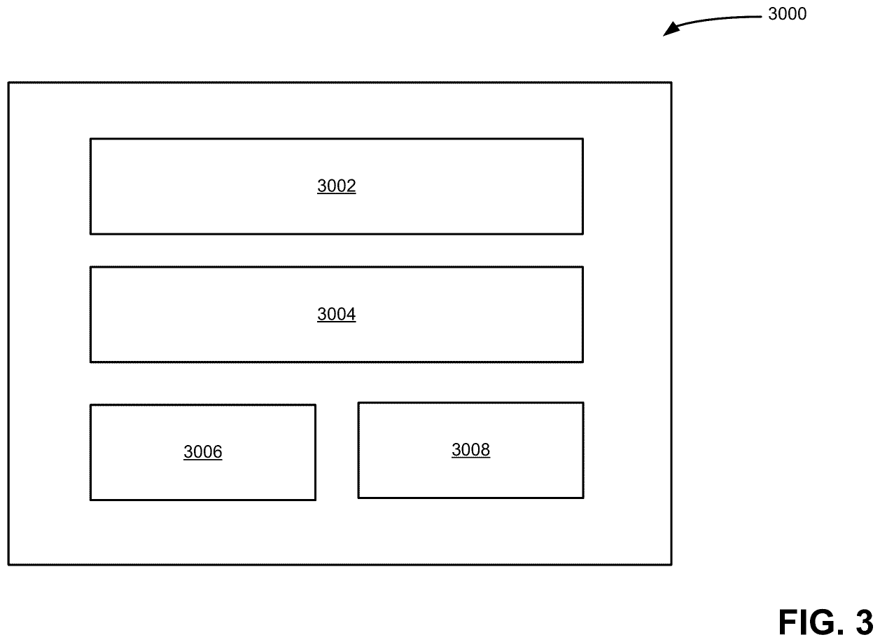

FIG. 2 is a flow diagram of a method 2000 of performing data analysis operations, in accordance with various embodiments. Although the operations of the method 2000 can be illustrated with reference to particular embodiments disclosed herein (e.g., the data analysis modules 1000 discussed herein with reference to FIG. 1, the GUI 3000 discussed herein with reference to FIG. 3, the computing devices 4000 discussed herein with reference to FIG. 4, and/or the data analysis system 5000 discussed herein with reference to FIG. 5), the method 2000 can be used in any suitable setting to perform any suitable data analysis operations. Operations are illustrated once each and in a particular order in FIG. 2, but the operations can be reordered and/or repeated as desired and appropriate (e.g., different operations performed can be performed in parallel, as suitable).

At 2002, DIA data can be received. In some embodiments, the data acquisition logic 1002 of a data analysis module 1000 can perform the operations of 2002. For example, the data acquisition logic 1002 can receive data generated by a mass spectrometer running in DIA mode about an analyte.

At 2004, chromatographic traces can be detected in the MS² domain. In some embodiments, the data processing logic 1004 of a data analysis module 1000 can perform the operations of 2004. The operations of 2004 can include any suitable chromatographic trace detection technique known in the art. In some embodiments, techniques that allow trace detection on the fly can be based on pattern recognition in real time as data is acquired by the mass spectrometer.

At 2006, peaks can be identified in the chromatographic traces detected at 2004. In some embodiments, the data processing logic 1004 of a data analysis module 1000 can perform the operations of 2006. The operations of 2006 can include performing any suitable peak detection technique known in the art.

At 2008, the peaks identified at 2006 can be grouped. In some embodiments, the data processing logic 1004 of a data analysis module 1000 can perform the operations of 2008. The peaks can be grouped at 2008 with the goal of having all related fragment peaks within one group. In some embodiments, one group can include fragment peaks from multiple peptides. The operations of 2008 can include calculating density metrics (e.g., in accordance with the techniques discussed in the master's thesis of S. Kusch regarding MALDI density), and/or binning on retention time (RT).

At 2010, spectrum peaks can be generated. In some embodiments, the data processing logic 1004 of a data analysis module 1000 can perform the operations of 2010. The operations of 2010 can include generating the mass over charge (m/z) using the m/z of mass trace (e.g., the average, mean, etc.), generating the intensity using the chromatographic peak area, and generating the RT using the RT of the associated peak group (e.g., the average, mean, etc.).

In one or more embodiments, additional centroids from neighborhood measured spectra can be used at 2010 to complete the spectrum. In some embodiments, additional information can be used at 2010 (e.g., MS1 scan data). For example, the one or more embodiments described herein can present minimized false negatives and/or spectra, such as to keep all options open for processing while still having satisfactory processing speed both for condensing information and downstream data analysis.

It is noted that generation of unbiased condensed data can be helpful downstream. That is, the enrichment of condensed spectra with information from neighborhood raw spectra can aid downstream processing because these neighborhood peaks collected from the environment can be of utility for confirmation of analytes, such as peptides, identified during post-processing. Searching for signals to preserve can be assisted by heuristics and/or can be guided by intensity or signal to noise ratio of the raw spectral peaks in the vicinity of the time location of a condensed spectrum. The enrichment can thus aid in reducing a false negative rate for downstream processing steps.

In one or more embodiments, such spectrum peaks can be generated absent the patterning process at 2004, and/or in parallel with the patterning process at 2004

At 2012, a spectrum can be written for each group. In some embodiments, the data writing logic 1006 of a data analysis module 1000 can perform the operations of 2006. The operations of 2012 can include any of a number of data writing techniques, such as writing the spectrum to a new data storage location (e.g., a file, etc.), adding or attaching the spectrum to an original raw file, writing the spectrum to a data stream, writing the spectrum to a new raw file (e.g., one directly created by the mass spectrometer), and/or other techniques. The spectrum data resulting from the operations of 2012 can be analyzed like data from regular DDA experiments.

In some embodiments, the method 2000 can result in significant data reduction from high-speed instrumentation and/or the number of scans not matching the acquisition frequency, if present. Condensed spectra can be assigned retention times that can be between retention times of spectra in the respective input data (e.g., initial measurement data 632).

The embodiments disclosed herein can allow derived raw files to be generated/converted from measured raw files. MS¹ spectra can be kept unchanged according to further research and/or customer preference.

In some embodiments, DDA-like raw files can be generated directly from an instrument without significant information loss. This can serve as high-end data compression and simplify obligations (e.g., regulatory obligations) to store raw data (e.g., in GxP or other regulated environments).

In some embodiments, integration (e.g., as a service or embedded) with the instrument can allow more rapid and/or efficient data analysis. In some embodiments, the systems and methods disclosed herein can be used with a suitable or preferred DDA search engine.

Some embodiments of the systems and methods disclosed herein can combine detection of chromatographic traces with deconvolution techniques, the value of data reduction, and grouping without peak shape and RT taken into consideration, resulting in conversion of DIA data into DDA data. Various embodiments can take different approaches to grouping and “completion” of derived spectra, as well as online trace detection through similarity of neighboring spectra. In some embodiments, reduction of data size and/or complexity can be achieved, enabling analysis of DIA data “on-the-fly” and providing an improvement over conventional approaches.

The data analysis methods disclosed herein can include interactions with a human user (e.g., via the user local computing device 5020 discussed herein with reference to FIG. 5). These interactions can include providing information to the user (e.g., information regarding the operation of a scientific instrument such as the scientific instrument 5010 of FIG. 5, information regarding an analyte being analyzed or other test or measurement performed by a scientific instrument, information retrieved from a local or remote database, or other information) or providing an option for a user to input commands (e.g., to control the operation of a scientific instrument such as the scientific instrument 5010 of FIG. 5, or to control the analysis of data generated by a scientific instrument), queries (e.g., to a local or remote database), or other information. In some embodiments, these interactions can be performed through a graphical user interface (GUI) that includes a visual display on a display device (e.g., the display device 4010 discussed herein with reference to FIG. 4) that provides outputs to the user and/or prompts the user to provide inputs (e.g., via one or more input devices, such as a keyboard, mouse, trackpad, or touchscreen, included in the other I/O devices 4012 discussed herein with reference to FIG. 5). The data analysis systems disclosed herein can include any suitable GUls for interaction with a user.

FIG. 3 depicts an example GUI 3000 that can be used in the performance of some or all of the data analysis methods disclosed herein, in accordance with various embodiments. As noted above, the GUI 3000 can be provided on a display device (e.g., the display device 4010 discussed herein with reference to FIG. 4) of a computing device (e.g., the computing device 4000 discussed herein with reference to FIG. 4) of a data analysis system (e.g., the data analysis system 5000 discussed herein with reference to FIG. 5), and a user can interact with the GUI 3000 using any suitable input device (e.g., any of the input devices included in the other I/O devices 4012 discussed herein with reference to FIG. 4) and input technique (e.g., movement of a cursor, motion capture, facial recognition, gesture detection, voice recognition, actuation of buttons, etc.).

The GUI 3000 can include a data display region 3002, a data analysis region 3004, a scientific instrument control region 3006, and a settings region 3008. The particular number and arrangement of regions depicted in FIG. 3 is simply illustrative, and any number and arrangement of regions, including any desired features, can be included in a GUI 3000.

The data display region 3002 can display data generated by a scientific instrument (e.g., the scientific instrument 5010 discussed herein with reference to FIG. 5).

The data analysis region 3004 can display the results of data analysis (e.g., the results of analyzing the data illustrated in the data display region 3002 and/or other data). In some embodiments, the data display region 3002 and the data analysis region 3004 can be combined in the GUI 3000 (e.g., to include data output from a scientific instrument, and some analysis of the data, in a common graph or region).

The scientific instrument control region 3006 can include options that allow the user to control a scientific instrument (e.g., the scientific instrument 5010 discussed herein with reference to FIG. 5).

The settings region 3008 can include options that allow the user to control the features and functions of the GUI 3000 (and/or other GUIs) and/or perform common computing operations with respect to the data display region 3002 and data analysis region 3004 (e.g., saving data on a storage device, such as the storage device 4004 discussed herein with reference to FIG. 4, sending data to another user, labeling data, etc.).

As noted above, the data analysis module 1000 can be implemented by one or more computing devices. FIG. 4 is a block diagram of a computing device 4000 that can perform some or all of the data analysis methods disclosed herein, in accordance with various embodiments. In some embodiments, the data analysis module 1000 can be implemented by a single computing device 4000 or by multiple computing devices 4000. Further, as discussed below, a computing device 4000 (or multiple computing devices 4000) that implements the data analysis module 1000 can be part of one or more of the scientific instrument 5010, the user local computing device 5020, the service local computing device 5030, or the remote computing device 5040 of FIG. 5.

The computing device 4000 of FIG. 4 is illustrated as having a number of components, but any one or more of these components can be omitted or duplicated, as suitable for the application and setting. In some embodiments, some or all of the components included in the computing device 4000 can be attached to one or more motherboards and enclosed in a housing (e.g., including plastic, metal, and/or other materials). In some embodiments, some of these components can be fabricated onto a single system-on-a-chip (SoC) (e.g., an SoC can include one or more processing devices 4002 and one or more storage devices 4004). Additionally, in various embodiments, the computing device 4000 may not include one or more of the components illustrated in FIG. 4, but can include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 4000 may not include a display device 4010, but can include display device interface circuitry (e.g., a connector and driver circuitry) to which a display device 4010 can be coupled.

The computing device 4000 can include a processing device 4002 (e.g., one or more processing devices). As used herein, the term “processing device” can refer to any device or portion of a device that processes electronic data from registers and/or memory to transform that electronic data into other electronic data that can be stored in registers and/or memory. The processing device 4002 can include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

The computing device 4000 can include a storage device 4004 (e.g., one or more storage devices). The storage device 4004 can include one or more memory devices such as random-access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 4004 can include memory that shares a die with a processing device 4002. In such an embodiment, the memory can be used as cache memory and can include embedded dynamic random-access memory (eDRAM) or spin transfer torque magnetic random-access memory (STT-MRAM), for example. In some embodiments, the storage device 4004 can include non-transitory computer readable media having instructions thereon that, when executed by one or more processing devices (e.g., the processing device 4002), cause the computing device 4000 to perform any appropriate ones of or portions of the methods disclosed herein.

The computing device 4000 can include an interface device 4006 (e.g., one or more interface devices 4006). The interface device 4006 can include one or more communication chips, connectors, and/or other hardware and software to govern communications between the computing device 4000 and other computing devices. For example, the interface device 4006 can include circuitry for managing wireless communications for the transfer of data to and from the computing device 4000. The term “wireless” and its derivatives can be used to describe circuits, devices, systems, methods, techniques, communications channels, etc., that can communicate data through the use of modulated electromagnetic radiation through a nonsolid medium. The term does not imply that the associated devices do not contain any wires, although in some embodiments they might not. Circuitry included in the interface device 4006 for managing wireless communications can implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). In some embodiments, circuitry included in the interface device 4006 for managing wireless communications can operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 4006 for managing wireless communications can operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 4006 for managing wireless communications can operate in accordance with Code Division Multiple Access (CDMA), Time Division Multiple Access (TOMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 4006 can include one or more antennas (e.g., one or more antenna arrays) to receipt and/or transmission of wireless communications.

In some embodiments, the interface device 4006 can include circuitry for managing wired communications, such as electrical, optical, or any other suitable communication protocols. For example, the interface device 4006 can include circuitry to support communications in accordance with Ethernet technologies. In some embodiments, the interface device 4006 can support both wireless and wired communication, and/or can support multiple wired communication protocols and/or multiple wireless communication protocols. For example, a first set of circuitry of the interface device 4006 can be dedicated to shorter-range wireless communications such as Wi-Fi or Bluetooth, and a second set of circuitry of the interface device 4006 can be dedicated to longer-range wireless communications such as global positioning system (GPS), EDGE, GPRS, CDMA, WiMAX, LTE, EV-DO, or others. In some embodiments, a first set of circuitry of the interface device 4006 can be dedicated to wireless communications, and a second set of circuitry of the interface device 4006 can be dedicated to wired communications.

The computing device 4000 can include battery/power circuitry 4008. The battery/power circuitry 4008 can include one or more energy storage devices (e.g., batteries or capacitors) and/or circuitry for coupling components of the computing device 4000 to an energy source separate from the computing device 4000 (e.g., AC line power).

The computing device 4000 can include a display device 4010 (e.g., multiple display devices). The display device 4010 can include any visual indicators, such as a heads-up display, a computer monitor, a projector, a touchscreen display, a liquid crystal display (LCD), a light-emitting diode display, or a flat panel display.

The computing device 4000 can include other input/output (I/O) devices 4012. The other I/O devices 4012 can include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the computing device 4000, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The computing device 4000 can have any suitable form factor for its application and setting, such as a handheld or mobile computing device (e.g., a cell phone, a smart phone, a mobile internet device, a tablet computer, a laptop computer, a netbook computer, an ultrabook computer, a personal digital assistant (PDA), an ultra mobile personal computer, etc.), a desktop computing device, or a server computing device or other networked computing component.

One or more computing devices implementing any of the data analysis modules or methods disclosed herein can be part of a data analysis system. FIG. 5 is a block diagram of an example data analysis system 5000 in which some or all of the data analysis methods disclosed herein can be performed, in accordance with various embodiments. The data analysis modules and methods disclosed herein (e.g., the data analysis module 1000 of FIG. 1 and the method 2000 of FIG. 2) can be implemented by one or more of the scientific instrument 5010, the user local computing device 5020, the service local computing device 5030, or the remote computing device 5040 of the data analysis system 5000.

Any of the scientific instrument 5010, the user local computing device 5020, the service local computing device 5030, or the remote computing device 5040 can include any of the embodiments of the computing device 4000 discussed herein with reference to FIG. 4, and any of the scientific instrument 5010, the user local computing device 5020, the service local computing device 5030, or the remote computing device 5040 can take the form of any appropriate ones of the embodiments of the computing device 4000 discussed herein with reference to FIG. 4.

The scientific instrument 5010, the user local computing device 5020, the service local computing device 5030, or the remote computing device 5040 can each include a processing device 5002, a storage device 5004, and an interface device 5006. The processing device 5002 can take any suitable form, including the form of any of the processing devices 4002 discussed herein with reference to FIG. 5, and the processing devices 5002 included in different ones of the scientific instrument 5010, the user local computing device 5020, the service local computing device 5030, or the remote computing device 5040 can take the same form or different forms. The storage device 5004 can take any suitable form, including the form of any of the storage devices 4004 discussed herein with reference to FIG. 5, and the storage devices 5004 included in different ones of the scientific instrument 5010, the user local computing device 5020, the service local computing device 5030, or the remote computing device 5040 can take the same form or different forms. The interface device 5006 can take any suitable form, including the form of any of the interface devices 4006 discussed herein with reference to FIG. 5, and the interface devices 5006 included in different ones of the scientific instrument 5010, the user local computing device 5020, the service local computing device 5030, or the remote computing device 5040 can take the same form or different forms.

The scientific instrument 5010, the user local computing device 5020, the service local computing device 5030, and the remote computing device 5040 can be in communication with other elements of the data analysis system 5000 via communication pathways 5008. The communication pathways 5008 can communicatively couple the interface devices 5006 of different ones of the elements of the data analysis system 5000, as shown, and can be wired or wireless communication pathways (e.g., in accordance with any of the communication techniques discussed herein with reference to the interface devices 4006 of the computing device 4000 of FIG. 5). The particular data analysis system 5000 depicted in FIG. 5 includes communication pathways between each pair of the scientific instrument 5010, the user local computing device 5020, the service local computing device 5030, and the remote computing device 5040, but this “fully connected” implementation is simply illustrative, and in various embodiments, various ones of the communication pathways 5008 can be absent. For example, in some embodiments, a service local computing device 5030 may not have a direct communication pathway 5008 between its interface device 5006 and the interface device 5006 of the scientific instrument 5010, but can instead communicate with the scientific instrument 5010 via the communication pathway 5008 between the service local computing device 5030 and the user local computing device 5020 and the communication pathway 5008 between the user local computing device 5020 and the scientific instrument 5010.

The scientific instrument 5010 can include any appropriate scientific instrument, such as a mass spectrometer and related instrumentation (e.g., chromatography instrumentation) or any other suitable instrumentation.

The user local computing device 5020 can be a computing device (e.g., in accordance with any of the embodiments of the computing device 4000 discussed herein) that is local to a user of the scientific instrument 5010. In some embodiments, the user local computing device 5020 can also be local to the scientific instrument 5010, but this need not be the case; for example, a user local computing device 5020 that is in a user's home or office can be remote from, but in communication with, the scientific instrument 5010 so that the user can use the user local computing device 5020 to control and/or access data from the scientific instrument 5010. In some embodiments, the user local computing device 5020 can be a laptop, smartphone, or tablet device. In some embodiments the user local computing device 5020 can be a portable computing device.

The service local computing device 5030 can be a computing device (e.g., in accordance with any of the embodiments of the computing device 4000 discussed herein) that is local to an entity that services the scientific instrument 5010. For example, the service local computing device 5030 can be local to a manufacturer of the scientific instrument 5010 or to a third-party service company. In some embodiments, the service local computing device 5030 can communicate with the scientific instrument 5010, the user local computing device 5020, and/or the remote computing device 5040 (e.g., via a direct communication pathway 5008 or via multiple “indirect” communication pathways 5008, as discussed above) to receive data regarding the operation of the scientific instrument 5010, the user local computing device 5020, and/or the remote computing device 5040 (e.g., the results of self-tests of the scientific instrument 5010, calibration coefficients used by the scientific instrument 5010, the measurements of sensors associated with the scientific instrument 5010, etc.). In some embodiments, the service local computing device 5030 can communicate with the scientific instrument 5010, the user local computing device 5020, and/or the remote computing device 5040 (e.g., via a direct communication pathway 5008 or via multiple “indirect” communication pathways 5008, as discussed above) to transmit data to the scientific instrument 5010, the user local computing device 5020, and/or the remote computing device 5040 (e.g., to update programmed instructions, such as firmware, in the scientific instrument 5010, to initiate the performance of test or calibration sequences in the scientific instrument 5010, to update programmed instructions, such as software, in the user local computing device 5020 or the remote computing device 5040, etc.). A user of the scientific instrument 5010 can utilize the scientific instrument 5010 or the user local computing device 5020 to communicate with the service local computing device 5030 to report a problem with the scientific instrument 5010 or the user local computing device 5020, to request a visit from a technician to improve the operation of the scientific instrument 5010, to order consumables or replacement parts associated with the scientific instrument 5010, or for other purposes.

The remote computing device 5040 can be a computing device (e.g., in accordance with any of the embodiments of the computing device 4000 discussed herein) that is remote from the scientific instrument 5010 and/or from the user local computing device 5020. In some embodiments, the remote computing device 5040 can be included in a datacenter or other large-scale server environment. In some embodiments, the remote computing device 5040 can include network-attached storage (e.g., as part of the storage device 5004). The remote computing device 5040 can store data generated by the scientific instrument 5010, perform analyses of the data generated by the scientific instrument 5010 (e.g., in accordance with programmed instructions), facilitate communication between the user local computing device 5020 and the scientific instrument 5010, and/or facilitate communication between the service local computing device 5030 and the scientific instrument 5010.

In some embodiments, one or more of the elements of the data analysis system 5000 illustrated in FIG. 5 may not be present. Further, in some embodiments, multiple ones of various ones of the elements of the data analysis system 5000 of FIG. 5 can be present. For example, a data analysis system 5000 can include multiple user local computing devices 5020 (e.g., different user local computing devices 5020 associated with different users or in different locations). In another example, a data analysis system 5000 can include multiple scientific instruments 5010, all in communication with service local computing device 5030 and/or a remote computing device 5040; in such an embodiment, the service local computing device 5030 can monitor these multiple scientific instruments 5010, and the service local computing device 5030 can cause updates or other information can be “broadcast” to multiple scientific instruments 5010 at the same time. Different ones of the scientific instruments 5010 in a data analysis system 5000 can be located close to one another (e.g., in the same room) or farther from one another (e.g., on different floors of a building, in different buildings, in different cities, etc.). In some embodiments, a scientific instrument 5010 can be connected to an Internet-of-Things (IoT) stack that allows for command and control of the scientific instrument 5010 through a web-based application, a virtual or augmented reality application, a mobile application, and/or a desktop application. Any of these applications can be accessed by a user operating the user local computing device 5020 in communication with the scientific instrument 5010 by the intervening remote computing device 5040. In some embodiments, a scientific instrument 5010 can be sold by the manufacturer along with one or more associated user local computing devices 5020 as part of a local scientific instrument computing unit 5012.

In some such embodiments, the remote computing device 5040 and/or the user local computing device 5020 can combine data from different types of scientific instruments 5010 included in a data analysis system 5000.

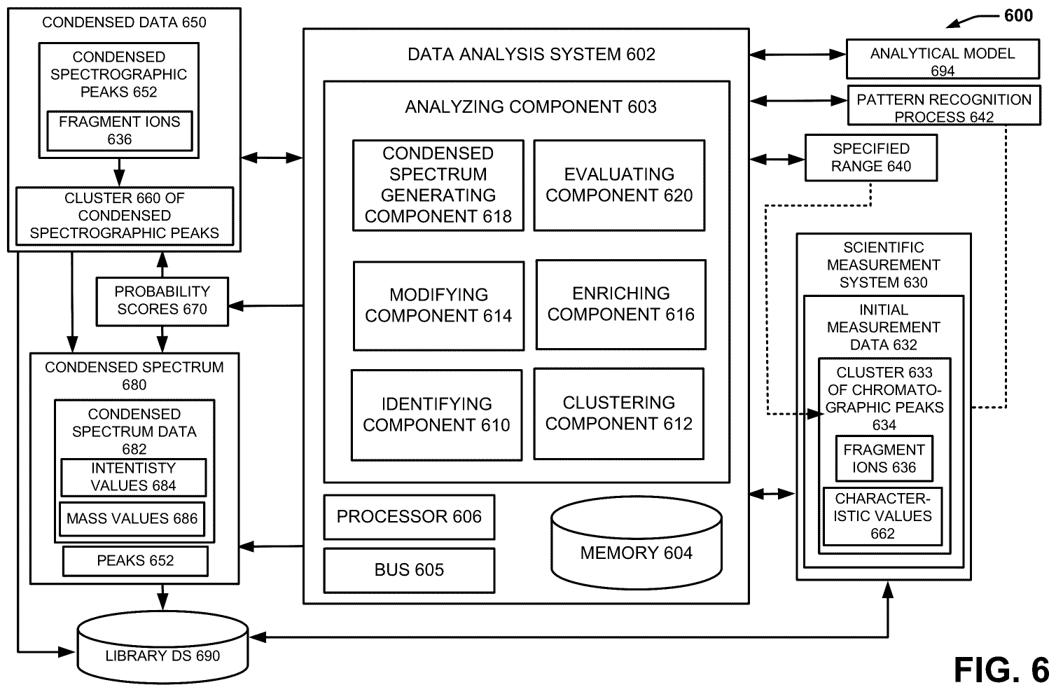

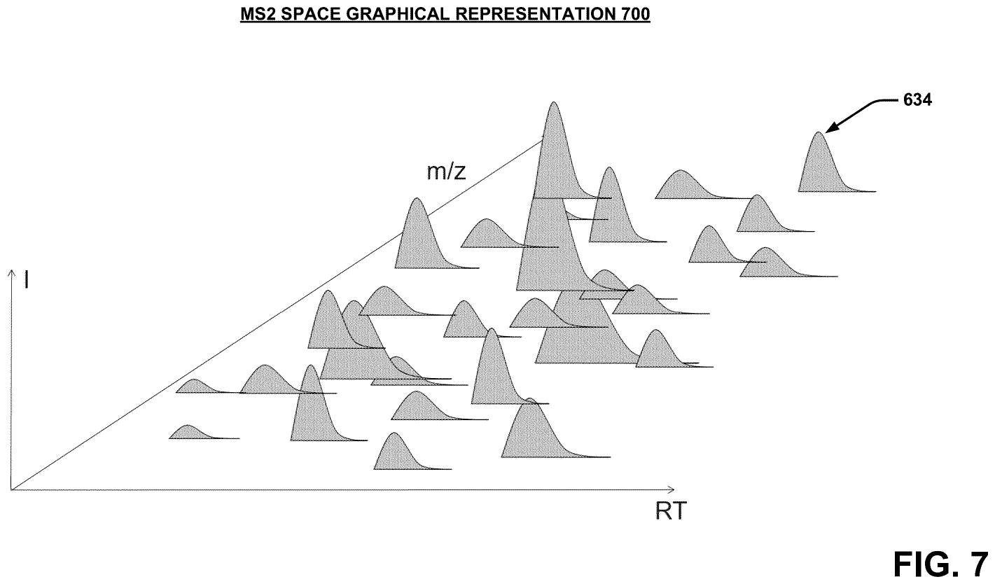

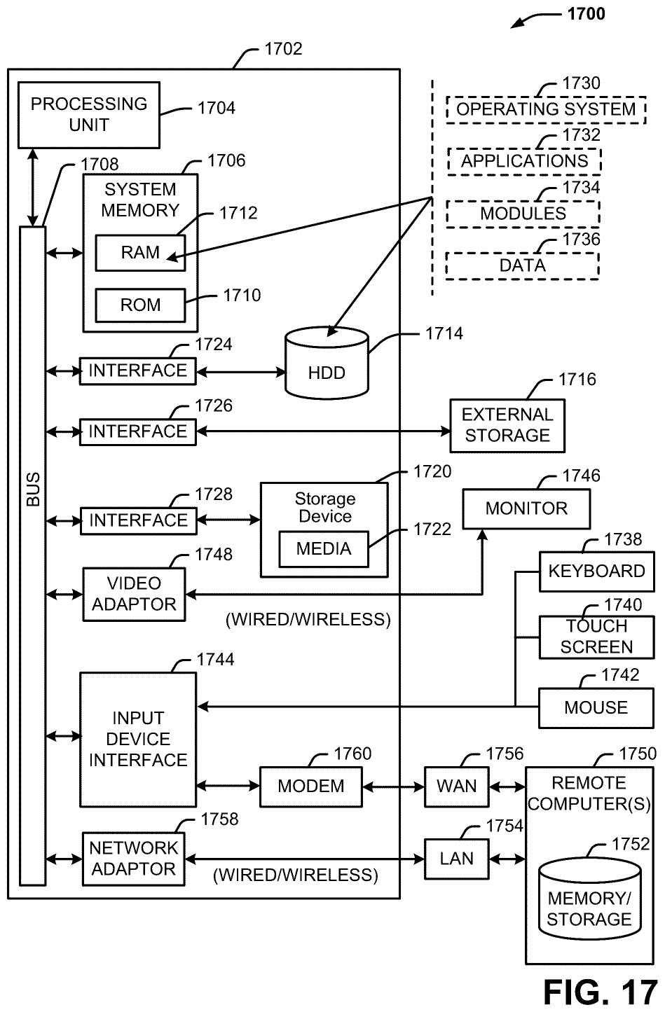

Referring next to FIGS. 6 and 7, illustrated is a non-limiting system 600 that can comprise one or more computer and/or computing-based elements described herein with reference to a computing environment, such as the computing environment 1700 illustrated at FIG. 17. In one or more described embodiments, computer and/or computing-based elements can be used in connection with implementing one or more of the systems, devices, components and/or computer-implemented operations shown and/or described in connection with FIGS. 6 and/or 7 and/or with other figures described herein.

The non-limiting system 600 is illustrated comprising a data analysis system 602, a scientific measurement system 630 and a library datastore (DS) 690. Repetitive description of like elements and/or processes employed in respective embodiments is omitted for sake of brevity.

In one or more embodiments, the scientific measurement system 630 can comprise a chromatography instrument, a spectrometry instrument and/or one or more controlling computing devices comprising at least one processor operatively coupled to a memory. In one or more embodiments, the scientific measurement system 630, can be separate from but communicatively couplable to the non-limiting system 600.

In one or more embodiments, the library datastore 690 be separate from but communicatively couplable to the non-limiting system 600. Data and/or metadata, comprising, but not limited to, the initial measurement data 632, condensed data 650 and/or condensed spectrum data 682, can be stored at the library datastore 690 in any suitable format.

Generally, the data analysis system 602 can facilitate acquiring of spectrometry data by a data independent acquisition (DIA) process and transformation of such data into condensed data 650/condensed spectrum data 682 on which data dependent acquisition (DDA) processes and/or DDA-like processes can be performed.

One or more communications between one or more components of the non-limiting system 600 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

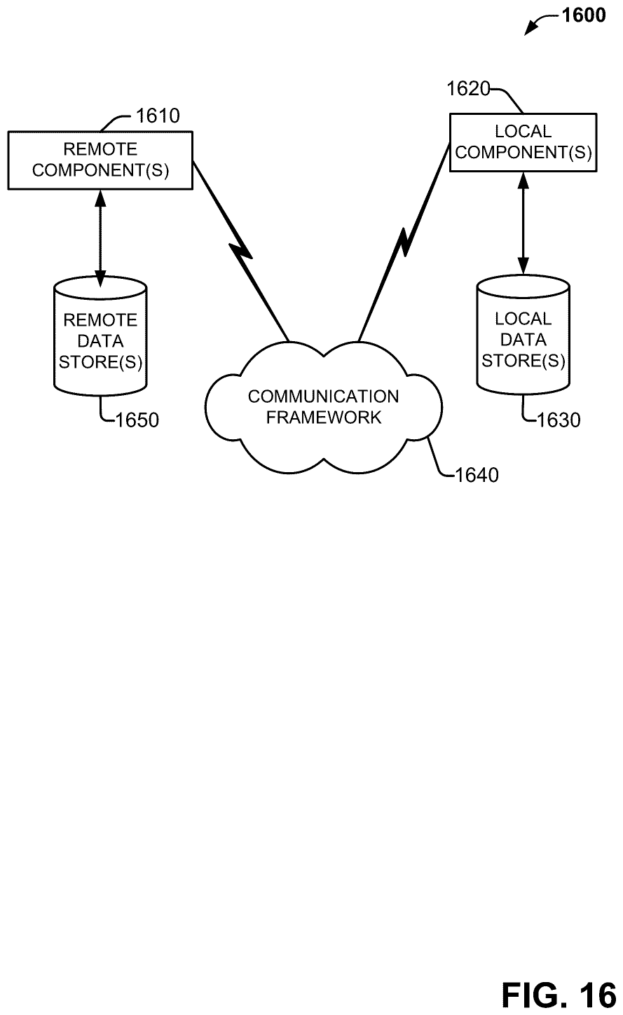

The data analysis system 602 can be associated with, such as accessible via, a cloud computing environment, such as the cloud computing environment 1600 of FIG. 16.

The data analysis system 602 can comprise a plurality of components. The components can comprise, but are not limited to, a memory 604, processor 606, bus 605, identifying component 610, clustering component 612, modifying component 614, enriching component 616, condensed spectrum generating component 618, and/or evaluating component 620. Using these components, the data analysis system 602 can acquire spectrometry data by a data independent acquisition (DIA) process, transform the data into condensed data 650/condensed spectrum data 682, and/or perform data dependent acquisition (DDA) based analysis processes on the condensed data 650/condensed spectrum data 682. This can allow for analysis of exhaustive and non-specifically acquired data based on selective analysis (e.g., DDA-based analysis).

Discussion next turns to the processor 606, memory 604 and bus 605 of the data analysis system 602. For example, in one or more example embodiments, the data analysis system 602 can comprise the processor 606 (e.g., computer processing unit, microprocessor, classical processor, quantum processor and/or like processor). In one or more example embodiments, a component associated with data analysis system 602, as described herein with or without reference to the one or more figures of the one or more example embodiments, can comprise one or more computer and/or machine readable, writable and/or executable components and/or instructions that can be executed by processor 606 to provide performance of one or more processes defined by such component and/or instruction. In one or more example embodiments, the processor 606 can comprise the identifying component 610, clustering component 612, modifying component 614, enriching component 616, condensed spectrum generating component 618, and/or evaluating component 620.

In one or more example embodiments, the data analysis system 602 can comprise the computer-readable memory 604 that can be operably connected to the processor 606. The memory 604 can store computer-executable instructions that, upon execution by the processor 606, can cause the processor 606 and/or one or more other components of the data analysis system 602 (e.g., identifying component 610, clustering component 612, modifying component 614, enriching component 616, condensed spectrum generating component 618, and/or evaluating component 620) to perform one or more actions. In one or more example embodiments, the memory 604 can store computer-executable components (e.g., identifying component 610, clustering component 612, modifying component 614, enriching component 616, condensed spectrum generating component 618, and/or evaluating component 620).

The data analysis system 602 and/or a component thereof as described herein, can be communicatively, electrically, operatively, optically and/or otherwise coupled to one another via a bus 605. Bus 605 can comprise one or more of a memory bus, memory controller, peripheral bus, external bus, local bus, quantum bus and/or another type of bus that can employ one or more bus architectures. One or more of these examples of bus 605 can be employed.

In one or more example embodiments, the data analysis system 602 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more example embodiments, one or more of the components of the data analysis system 602 and/or of the non-limiting system 600 can reside in the cloud, and/or can reside locally in a local computing environment (e.g., at a specified location).

In addition to the processor 606 and/or memory 604 described above, the data analysis system 602 can comprise one or more computer and/or machine readable, writable and/or executable components and/or instructions that, when executed by processor 606, can provide performance of one or more operations defined by such component and/or instruction.

Discussion next turns to the additional components of the data analysis system 602 (e.g., identifying component 610, clustering component 612, modifying component 614, enriching component 616, condensed spectrum generating component 618, and/or evaluating component 620).

The processes performed by the data analysis system 602 can be broken down into a set of processes including, but not limited to: a first set of processes for acquiring spectrometry data by a data independent acquisition (DIA) process, a second set of processes for transforming the data into condensed data 650/condensed spectrum data 682, and a third set of processes for performing data dependent acquisition (DDA)-based analysis processes on the condensed data 650/condensed spectrum data 682.

First, it is noted that in one or more example embodiments, the identifying component 610, clustering component 612, modifying component 614, enriching component 616, condensed spectrum generating component 618, and/or evaluating component 620 can be implemented independently, without one or more other of the identifying component 610, clustering component 612, modifying component 614, enriching component 616, condensed spectrum generating component 618, and/or evaluating component 620. Additionally and/or alternatively, the identifying component 610, clustering component 612, modifying component 614, enriching component 616, condensed spectrum generating component 618, and/or evaluating component 620 can be comprised by a high-level analyzing component 603, one or more of the below-described functions of the obtaining identifying component 610, clustering component 612, modifying component 614, enriching component 616, condensed spectrum generating component 618, and/or evaluating component 620 can be performed by the high-level analyzing component 603, and/or the identifying component 610, clustering component 612, modifying component 614, enriching component 616, condensed spectrum generating component 618, and/or evaluating component 620 can be omitted with the high-level analyzing component 603 performing one or more of the below-described functions of the one or more omitted identifying component 610, clustering component 612, modifying component 614, enriching component 616, condensed spectrum generating component 618, and/or evaluating component 620.

As noted above, a first set of one or more processes can comprise acquiring spectrometry data by a data independent acquisition (DIA) process.

That is, the identifying component 610 can direct the scientific measurement system 630 to perform data independent acquisition on an analyte resulting in fragment ions 636. Alternatively, the scientific measurement system 630 can have already performed the DIA processes.

As such, the identifying component 610, using the initial measurement data 632 obtained by DIA, identify a cluster 633 of chromatographic peaks 634 corresponding to the fragment ions 636.

In connection therewith, representation 700 at FIG. 7 illustrates a portion of an MS² space graphed by retention time (RT) at the x-axis, mass-to-charge ration (m/z) at the y-axis and intensity (I) at the z-axis. Illustrated are a plurality of chromatographic peaks 634 extending over a retention time window.

Relative to FIG. 7, chromatography data can generally comprise a set of data (e.g., data and/or metadata) in any suitable form. One or more chromatograms can be generated by and/or defined by (e.g., without specific graphing thereof) the chromatography data. In one or more cases, chromatography data can comprise correspondences of time and conductivity. Time can be employed in any suitable unit, such as seconds, minutes, etc., without being limited thereto. Conductivity can be employed in any suitable units, such as μS/cm, without being limited thereto. Mass or mass to charge ratio can be employed in any suitable units, such as Th, Da, u, and/or m/z.

Referring still to FIG. 6, the clustering component 612 can identify one or more chromatographic traces of the initial measurement data 632 in the MS² domain and cluster the one or more chromatographic traces.

For example, the clustering component 612 can generally identify a group of chromatographic peaks 634, of the initial measurement data 632, having characteristic values 662 within a specified range of characteristic values 662 under the peaks, and can identify the group of chromatographic peaks 634 as a specified cluster 633 of chromatographic peaks 634.

In one or more cases, the characteristic values 662 can comprise, but are not limited to, an area under a cluster 633 of chromatographic peaks 634, a peak intensity from an ion trace of a cluster 633 of chromatographic peaks 634, and/or a mean, average, or intensity-weighted average mass from an ion trace of a cluster 633 of chromatographic peaks 634. The characteristic values 662 can comprise any one or more of mass, intensity over area, retention time, serial number, flags, ion time, charge state, instrument, identified (e.g., isotopic) clusters, and/or ion mobility information.

For example, the clustering component 612 can identify one or more groups of chromatographic peaks 634, of the initial measurement data 632, having retention times, peak intensities, and/or area under the peaks within a specified range of retention times, peak intensities, or area under the peaks. That is, the clustering component 612 can identify the group of chromatographic peaks 634 as a specified cluster 633 of chromatographic peaks 634.

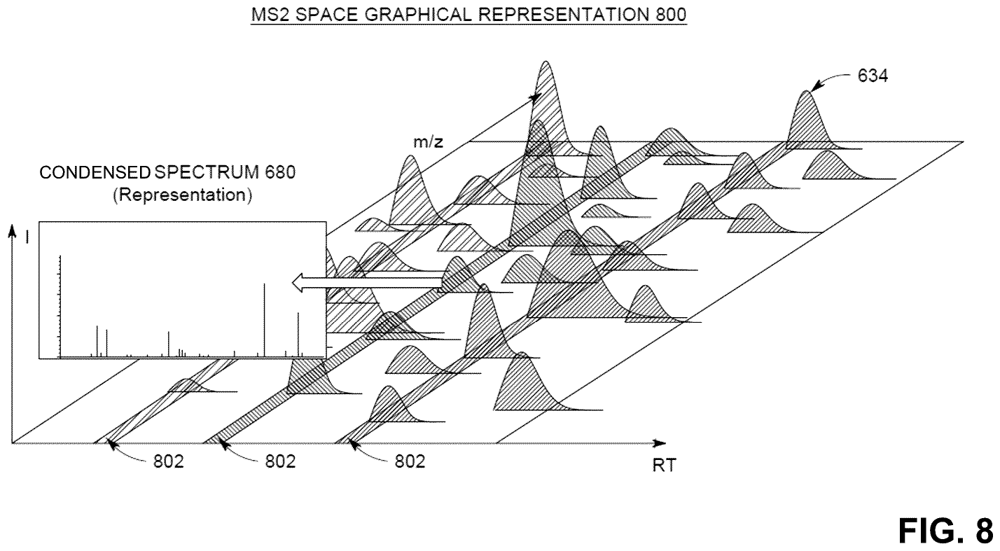

That is, peak-based spectra-clusters can be derived by grouping detected peaks 634 (e.g., defined by apex RT and apex m/z) within a specified/defined retention time window 802. See, e.g., illustration 800 at FIG. 8 where three different retention time windows 802 are illustrated.

This process can comprise a set of sub-steps comprising detecting peaks 634 using ion traces and then performing any one or more of a set of secondary sub-steps. The secondary sub-steps can comprise, but are not limited to: grouping in fixed RT windows (regular adjacent RT windows collecting all peaks in the window), grouping in overlapping RT windows, top-down based grouping starting with a largest peak (highest apex intensity or largest area under curve/AUC), defining an RT window around the highest peak and using the RT window to gather all peaks coeluting together with the highest peak, grouping of peaks by applying a density matrix identifying regions of larger sum of AUC changes in a graph plotting a summed AUC of all peaks over RT, and/or grouping peaks with similar RT and similar peak shape using only MS² information.

In one or more embodiments, different clusters 633 can be generated using different ones of the above-noted sub-steps.

Additionally, and/or alternatively, in one or more embodiments, same clusters 633 can be verified and/or modified using more than one of the above-noted sub-steps.

Additionally, and/or alternatively, the clustering component 612 can identify the one or more groups of chromatographic peaks 634, and/or any one or more other groups of chromatographic peaks 634, of the initial measurement data 632, by employing a pattern recognition process 642, such as on a graphical representation (e.g., 700 or 800) of the initial measurement data 632 based on specified intensity, retention time or mass ranges. That is, the clustering component 612 can identify the group of chromatographic peaks 634 as the cluster 633 or another cluster 633 of chromatographic peaks 634.

For example, a trained model and/or pattern recognition algorithm/model can be employed on an image representation (e.g., representation 700 and/or 800) of measured data (e.g., the initial measurement data 632. Based on specific types of data, corresponding specific trained models can be applied. For example, filtering of data peaks 636 can be based on application, such as in proteomics filtering for peptide fragment relevant m/z ranges.

This process can comprise creating two-dimensional images and/or three-dimensional images of the measured data (e.g., RT vs. m/z and color-coded intensities), and detecting and clustering ion traces based on the created images.

For another example, a sparse matrix of mass spectra vs. time can be converted to a two-dimensional image such that an image processing method, such as a pattern recognition method, can be applied to the data. The mapping to such image file may include a reduction of the mass resolution, time resolution, or both. In one or more cases, image detection can be guided to identify one or more groups parallel to the mass axis, which can represent coincidence in time. In one or more cases, the output can be viewed as time centroided sets of mass centroids.

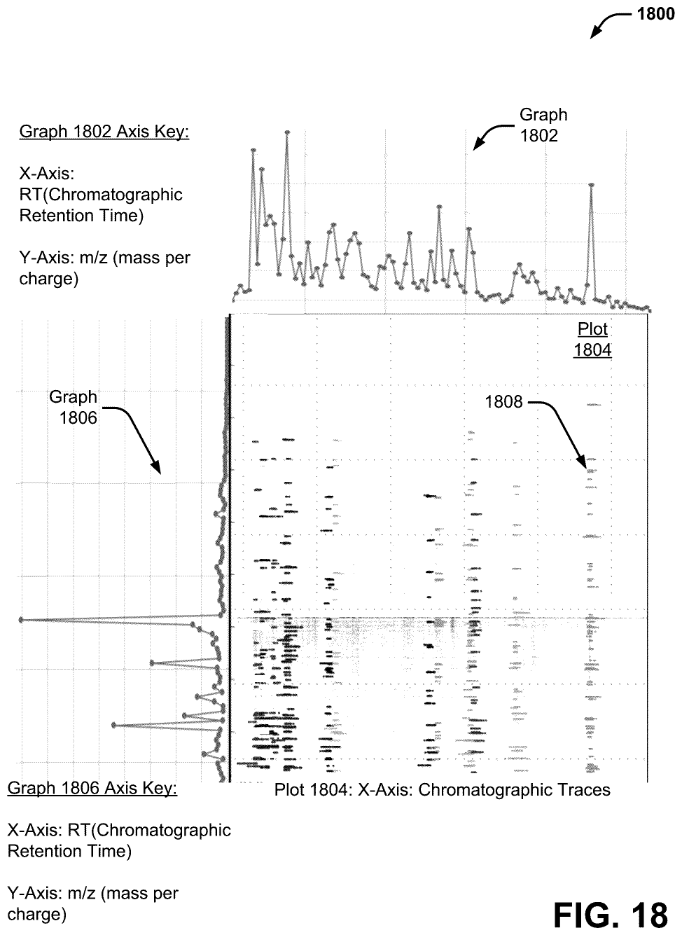

For example, FIG. 18 provides an illustration 1800, where a curve 1802 is a total ion chromatogram of the data in the image window 1804. The vertical curve 1806 is a condensed mass spectrum for the image window 1804. The highlighting 1808 represents allocation to identified clusters of chromatographic peaks (e.g., trace-group detections are highlighted).

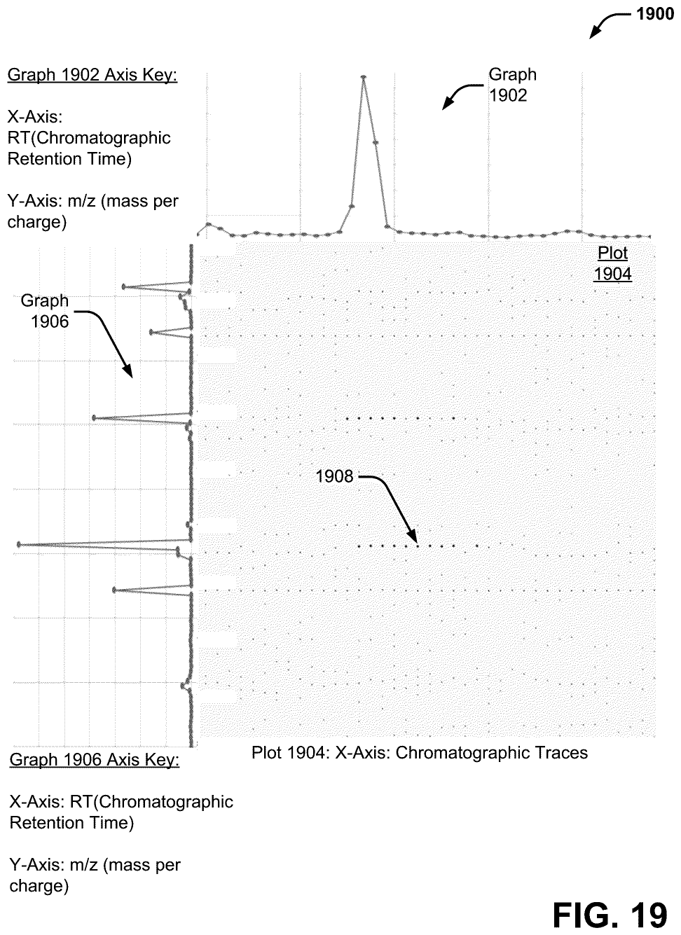

For another example, FIG. 19 and illustration 1900 illustrate a curve 1902 of a total ion chromatogram for a single cluster of the data in the image window 1904. The vertical curve 1905 is a condensed mass spectrum for the image window 1904. The highlighting 1908 represents allocation to identified clusters of chromatographic peaks (e.g., trace-group detections are highlighted).

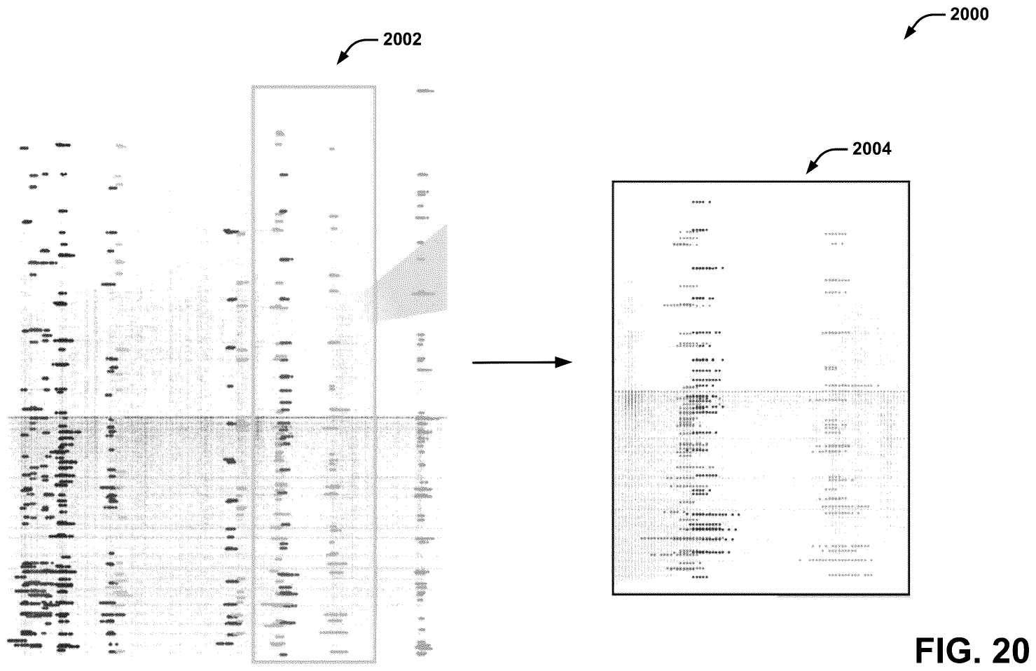

For still another example, FIG. 20 and illustration 2000 illustrate association of data 2002 to one another at representation 2004, guided by being parallel to a respective mass axis, i.e., close to one another in time.

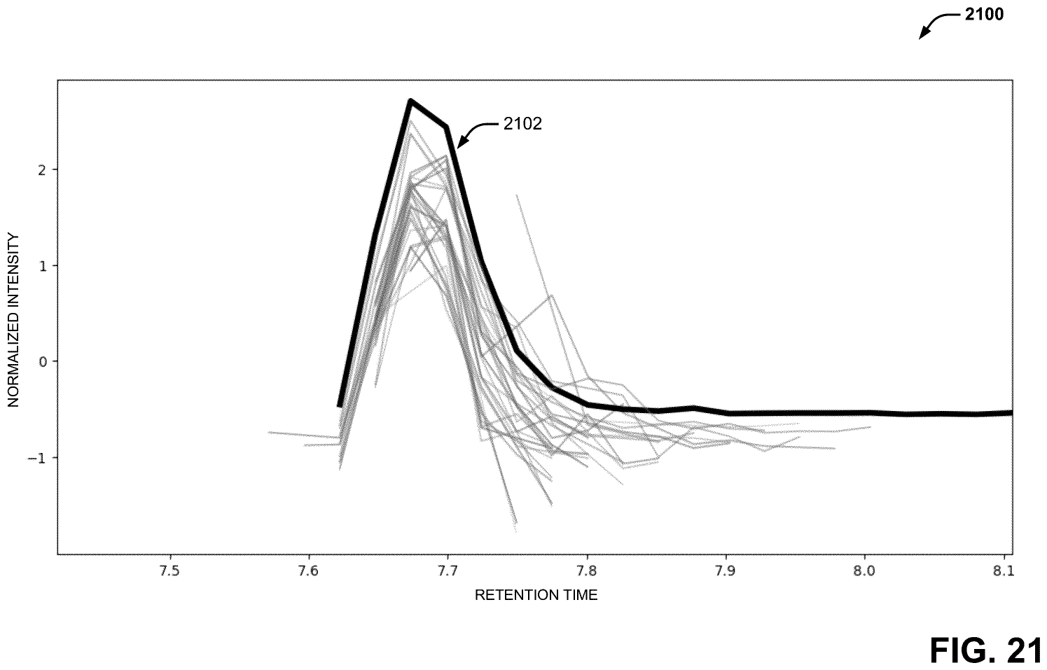

The graph 2100 at FIG. 21 illustrates intensity curves 2102, the data from which can be used for determination of a time centroid relative to the representation 2004 at FIG. 20.

In one or more cases, cluster recognition can be assisted by machine learning, such as employing an analytical model 694 (e.g., artificial intelligence model, machine learning model, neural network model, deep neural network model, convoluted neural network model, image processing model, etc.), such as a machine learning model. The analytical model 694 can be comprised by the non-limiting system 600. The analytical model 694 can be comprised by and/or separate from (e.g., communicatively coupled to) the data analysis system 602.

Training of respective cluster recognition for the analytical model 694 can be performed by the processor 606, for example. The training can comprise using curated data with traces where clustering has been performed by downstream data processing using databases or libraries of measured or simulated spectra, e.g., peptides or small molecules, such as metabolites. This can provide clustering by external knowledge, e.g., masses of fragments that are known to belong together because of appearing in a library together.

Additionally, and/or alternatively, training can comprise developing a metric of cluster traces that belong together.

Training output can be optimized to return clusters that contain more peaks than predicted by the library but that do not overshoot, and/or do not exceed a threshold), to contain too many additional traces. The overshoot limitation can employ intensity and/or signal to noise information, a limitation of the distance of the time centroid of a trace to the time centroid of the cluster of ions/fragments (e.g., known, accepted ions/fragments) by the expected width of a chromatographic peak, and/or simply a regularization, such as that penalizes high numbers of clusters (e.g., compare to Occam's Razor).

In one or more embodiments, different clusters 633 can be generated using different ones of the above-noted processes.

Additionally, and/or alternatively, in one or more embodiments, same clusters 633 can be verified and/or modified using more than one of the above-noted processes.

Furthermore, while one or more examples described herein can be related to identification using an RT window, one or more other clusters 633 can be identified using a m/z window, intensity window, and/or a window having a combination of RT, m/z and/or intensity parameters.

Next, as noted above, a second set of one or more processes can comprise transforming the data into condensed data 650/condensed spectrum data 682.

For example, in one or more embodiments, relative to the one or more different clusters 633 identified by the clustering component 612, the modifying component 614 can cluster a condensed spectrographic peak 634, corresponding to a first fragment ion 636, and a second condensed spectrographic peak 634, corresponding to a second fragment ion 636, which second fragment ion 636 has not yet been identified as being comprised by the cluster 633 of chromatographic peaks 634 or any other cluster 633 of chromatographic peaks 634. This clustering can be performed by normalizing a mass value 686 of the second condensed spectrographic peak 634 to a mass value 686 of the condensed spectrographic peak 634.

For example, the condensed spectrum generating component 618 can generate a condensed spectrum 680 comprising one or more condensed spectrographic peaks 652 each having an intensity value 684 and a mass value 686 that are based on characteristic values 662 aggregated from the cluster 633 of chromatographic peaks 634.

The characteristic values 662 can comprise, but are not limited to, an area under a cluster 633 of chromatographic peaks 634, a peak intensity from an ion trace of a cluster 633 of chromatographic peaks 634, and/or a mean, average, or intensity-weighted-average mass from an ion trace of a cluster 633 of chromatographic peaks 634. The characteristic values 662 can comprise any one or more of mass, intensity over area, retention time, serial number, flags, ion time, charge state, instrument, identified (e.g., isotopic) clusters, and/or ion mobility information.

That is, the condensed spectrum generating component 618 can generate the intensity value 684 based on the characteristic values 662 comprising an area under an ion trace or a peak intensity from an ion trace in the cluster 633 of chromatographic peaks 634.

Likewise, the condensed spectrum generating component 618 can generate the mass value 686 based on the characteristic values 662 comprising an area under an ion trace or a peak intensity from an ion trace in the cluster of chromatographic peaks 634. Put another way, the condensed spectrum generating component 618 can generate the mass value 686 based on the characteristic values comprising a mean, average, or intensity-weighted-average mass from an ion trace of the cluster 633 of chromatographic peaks 634.

Put another way, a pseudo-mass peak can have a pseudo-intensity from a detected peak area or peak intensity from the corresponding ion trace in the corresponding cluster 633. Pseudo-mass peaks can have pseudo-mass from the detected ion trace, e.g. as an average, mean, intensity weighted average mass from the ion trace. Further, condensed spectra RT can be calculated based on an average (e.g., a weighted average) of detected peak-RTs. Also, condensed spectra precursor mass can be derived by the condensed spectrum generating component 618 by using a DIA isolation window mass and/or a correlated MS² mass trace of an unfragmented ion of the analyte.

Further, the condensed spectrum generating component 618 can generate the retention time of a condensed spectrographic peak 652 based on characteristic values 662 comprising any one or more of a mean, median, weighted average and/or expected value (e.g., a first moment of the observed RT distribution) of the retention times of ion traces of a cluster 633 of corresponding chromatographic peaks 634.

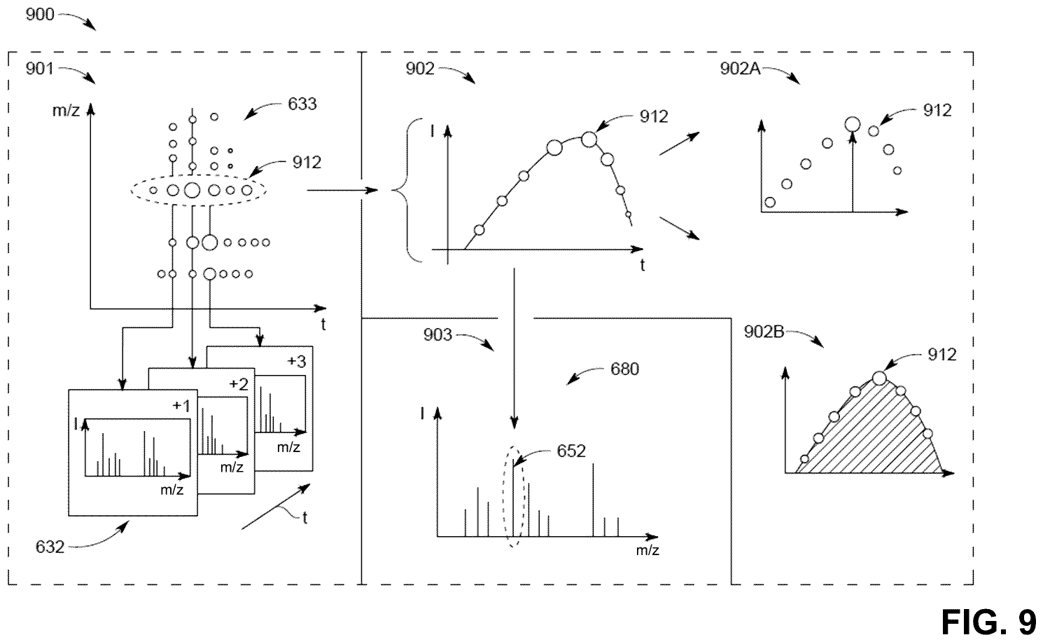

For a brief summary, and turning briefly to FIG. 9, illustrated at graph 901 is a representation of a cluster 633 of chromatographic peaks 634, with a circled ion trace 912, and corresponding to one or more measured spectrum (e.g., of the initial measurement data 632, such as DIA measurement data). As used herein, an ion trace 912 (e.g., also referred to as an extracted ion chromatogram, XIC) can be the intensity for a single mass-to-charge ratio as a function of time.

At graph 902 of FIG. 9, illustrated is an ion trace 912 corresponding to the ion trace 912 of graph 901, but represented as intensity vs. time for a single m/z at graph 902.

At graph 902A, illustrated is a representation of the ion trace 912 as intensity.

At graph 902B, illustrated is a representation of the ion trace 912 as area under the curve (AUC).

At graph 903, illustrated is a condensed spectrum 680 comprising the ion trace 912 represented as an identified, single condensed spectrographic peak 682.

The condensed spectrum generating component 618 can store the condensed spectrum 680, condensed data 650, and/or condensed spectrum data 682 as condensed mass spectrometry data, such as at the library datastore 690.

In one or more embodiments, the condensed spectrum generating component 618 can generate the condensed spectrum data 682 during data acquisition, such as during collection of the initial measurement data 632, such as DIA data, by the scientific measurement system 630 and/or obtaining of the initial measurement data 632 from the scientific measurement system 630 and/or an associated datastore, such as the information datastore 690 (also herein referred to as a library datastore 690). In other words, as the scientific measurement system 630 is collecting and/or acquiring raw data in a DIA mode, the data analysis system 602, and specifically the condensed spectrum generating component 618, can process the DIA data in parallel to the raw instrument data acquisition to generate and write condensed spectrum data 682 and/or condensed data 640, defining one or more condensed spectrographic peaks 652 and/or condensed spectrums 680. This generating can be performed by the condensed spectrum generating component 618 while the scientific measurement system 630 continues raw data acquisition in DIA mode and/or while the identifying component 610 obtains such DIA data (e.g., initial measurement data 632) from the scientific measurement system 630 and/or an associated datastore, such as the information datastore 690.

Put another way, the condensed spectrum data 682 can be determined and written while the data analysis system 602 is performing data acquisition (e.g., by the identifying component 610), instead of, and/or in addition to, first performing the data acquisition and then performing the condensed spectrum generating by the condensed spectrum generating component 618.

One or more advantages of this parallel-processing can comprise, but is not limited to, data size transported being reduced. For example, in regulated environments usually the first persisted data set is preserved for a long amount of time. The data reduction provided by the one or more embodiments described herein can become a technical and financial advantage. The data reduction provided by the one or more embodiments described herein can reduce doubt about what could be seen from the raw data in hindsight.

Downstream processing, such as identification and quantitation of substances, can be accelerated because the uncondensed raw data is not again parsed one or more times. It is noted that discussion here can be relevant to many gigabytes per experiment for parsing of liquid chromatography-mass spectrometry (LCMS) files and to many petabytes of persistent storage for long term archiving with an estimated data reduction by a factor of 5, 10, or more.

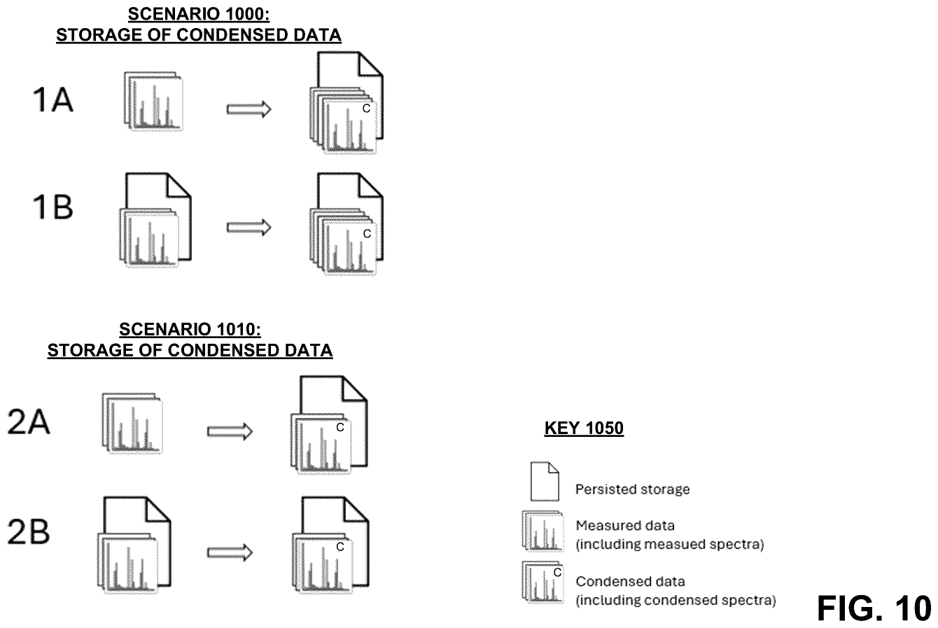

In one or more cases, there can be three preferred data systems for the condensation process: 1) the instrument that does the data acquisition, 2) the computer that provides the data storage, 3) a compute service between the instrument and the data acquisition and the data storage computer. Further discussion is provided below relative to FIGS. 10-13.

In one or more embodiments, the condensed spectrum generating component 618 can generate the condensed spectrum data 682 absent any one or more (or all) clustering operations described above as being performed by the clustering component 612 and/or absent any one or more (or all) pattern recognition processes described above as being performed by the clustering component 612, trained model and/or pattern recognition algorithm/model. This generation by the condensed spectrum generating component 618 can be performed during data acquisition, such as during collection of the initial measurement data 632, such as DIA data, by the scientific measurement system 630 and/or obtaining of the initial measurement data 632 from the scientific measurement system 630 and/or an associated datastore, such as the information datastore 690.

In any of the above-described embodiments, the enriching component 616 can generate one or more probability scores 670, for condensed spectrographic peaks 634. The probability scores 670 can be representative of the condensed spectrographic peaks 652 being comprised by a cluster 660 of the condensed spectrographic peaks 652 having mass, m/z, intensity, RT and/or shape within a specified range of mass, m/z, intensity, RT or shape.

That is, condensed spectra 680 can be enriched with measured mass peaks from RT neighboring measured spectra, which do not belong already to a detected trace. In such case, intensities of those mass peaks can be adjusted to keep a ratio of intensities of the condensed spectra 680 consistent, e.g. based on peaks within the measured spectra, which contribute to traces in the spectra cluster. Measured mass peak candidates for enrichment can be selected based on specific experiment types e.g. proteomics, small molecules to reflect expected fragmentation rules of the analyte.

It is further appreciated that after the condensed spectrum generating component 618 assembles the clustered peaks 634 in a condensed spectrum 680, the continuing with the next largest peaks in the list of remaining peaks, until all peaks are assembled to condensed spectra. Further, such additional clustering and generating can be performed at least partially in parallel with one another for two or more clusters 633 and/or condensed spectrums 680.

As noted above, a third set of one or more processes can comprise performing data dependent acquisition (DDA)-based analysis processes on the condensed data 650/condensed spectrum data 682.

That is, the evaluating component 620 can analyze and/or direct analysis of condensed spectrum data 682 underlying the condensed spectrum 680 by employing a data evaluation method as employed for analysis of data from data dependent acquisition analysis.

In one or more embodiments, the data evaluation method can employ precursor ion information. For example, the identifying component 610 and/or evaluating component 620 can determine a precursor mass or precursor mass range. For another example, the identifying component 610 and/or evaluating component 620 can determine the precursor mass or precursor mass range from a mass isolation window corresponding to the data independent acquisition, from identifying or correlating a corresponding one or more precursor ions observed within the data independent acquisition mass isolation window in a non-fragmenting mass analysis, from precursor ions identified by analysis of the data independent analysis mass spectrum.

Turning next briefly to FIGS. 10 to 13, illustrated are varying sequences of condensed data (e.g., pseudo-data) handling that can be employed by the data analysis system 602 relative to the varying identifying, clustering and/or spectrum-generating steps discussed above. For all groups of peaks of the exhaustive DIA data, corresponding condensed spectra (e.g., synthetic DDA spectrum and/or pseudo-spectrum) can be generated. What kind of data is stored as raw data and where the data is generated and stored can be distinguished from one another relative to these sequences.

Looking to scenarios 1000 at FIG. 10 and to associated key 1050, options for storing such condensed data can comprise storing the condensed spectra together with measured spectra in a persisted storage, such as in a raw data file or raw data stream.

At scenario 1010 of FIG. 10, relative to key 1050, the condensed spectra can be alternatively stored without the measured spectra in a persisted storage, such as in a raw data file or raw data stream.

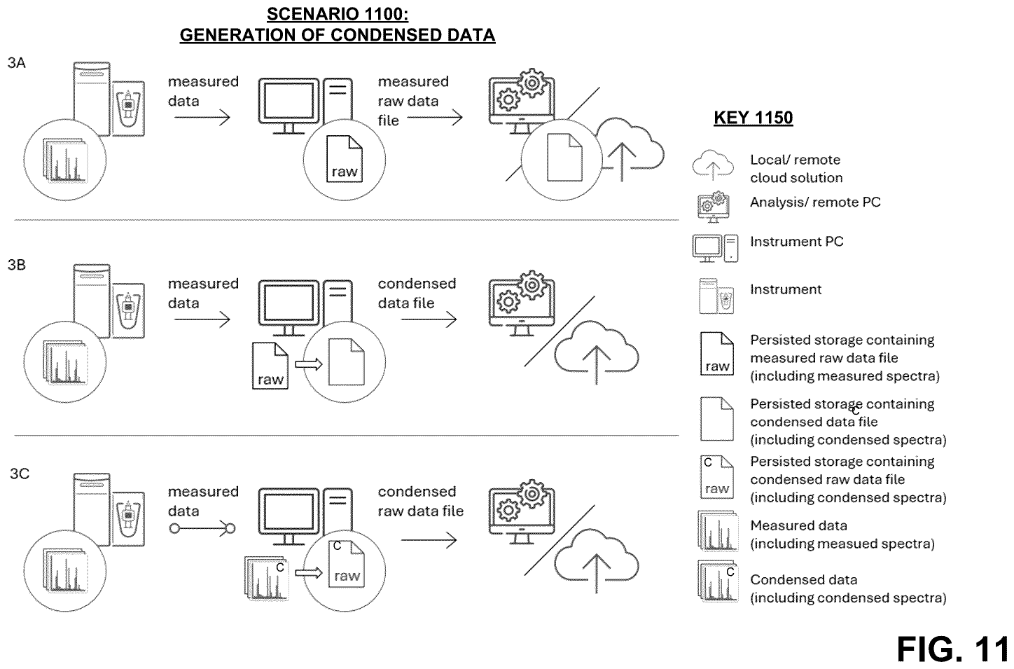

Turning to FIG. 11, to scenario 1100, and to key 1150, illustrated are varying sequences for generation of the condensed data. For example, an instrument can acquire and send measured data (e.g., including a collection of measured spectra) to a storage device (e.g., a computerized device such as a local and/or remote computer, cloud solution, server, etc.). That is, as illustrated between scenarios 3A, 3B and 3C, measured data can be stored as measured raw data (scenario 3A), measured data can be transformed to and stored as condensed data (scenario 3B), and/or measured data can be transformed to and stored as condensed raw data (scenario 3C).

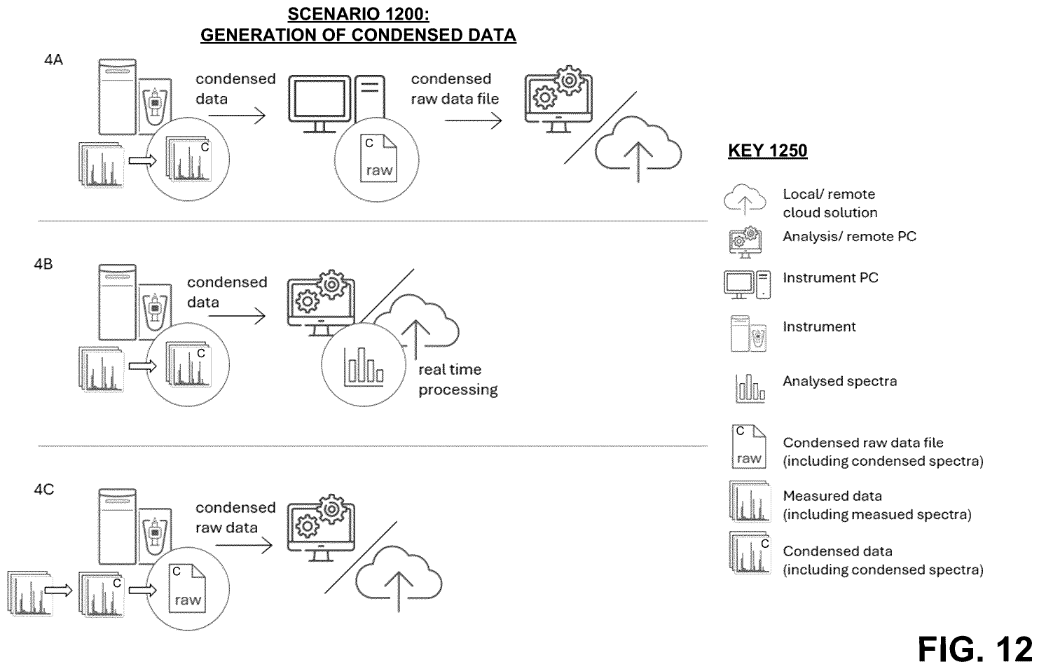

Turning to FIG. 12, to scenario 1200, and to key 1250, illustrated are other varying sequences for the generation of the condensed data. For example, an instrument can acquire and send measured data (e.g., including a collection of measured spectra) to a storage device (e.g., a computerized device such as a local and/or remote computer, cloud solution, server, etc.). That is, as illustrated between scenarios 4A and 4B, local storage can be employed (scenario 4A) or not employed (scenario 4B) between generation of condensed data and analysis/storage processes for condensed raw data. Alternatively, at scenario 4C, condensed raw data can be directly analyzed and stored.

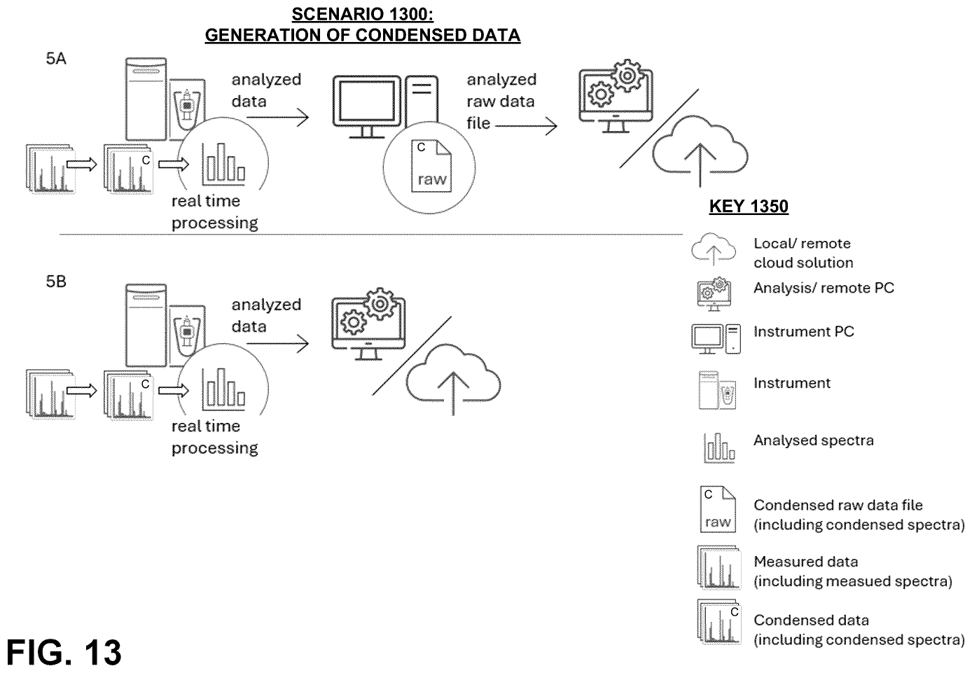

Turning to FIG. 13, to scenario 1300, and to key 1350, illustrated are further varying sequences for the generation of the condensed data. For example, an instrument can acquire and send measured data (e.g., including a collection of measured spectra) to a storage device (e.g., a computerized device such as a local and/or remote computer, cloud solution, server, etc.). That is, as illustrated between scenarios 5A and 5B, local storage can be employed (scenario 5A) or not employed (scenario 5B) between real time processing of condensed data and analysis/storage processes for condensed raw data.

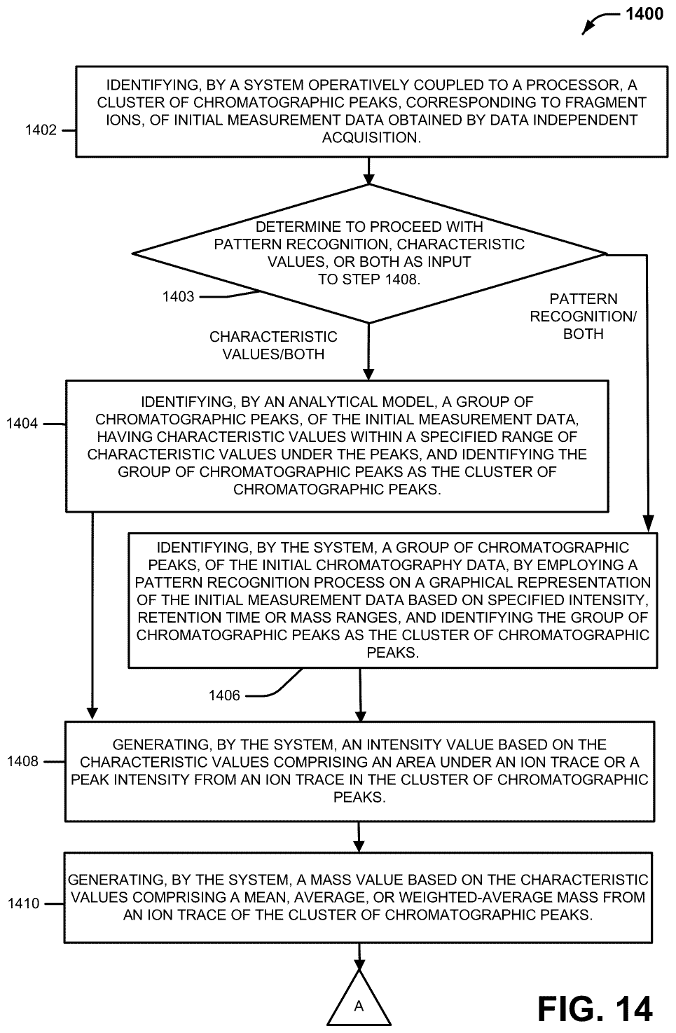

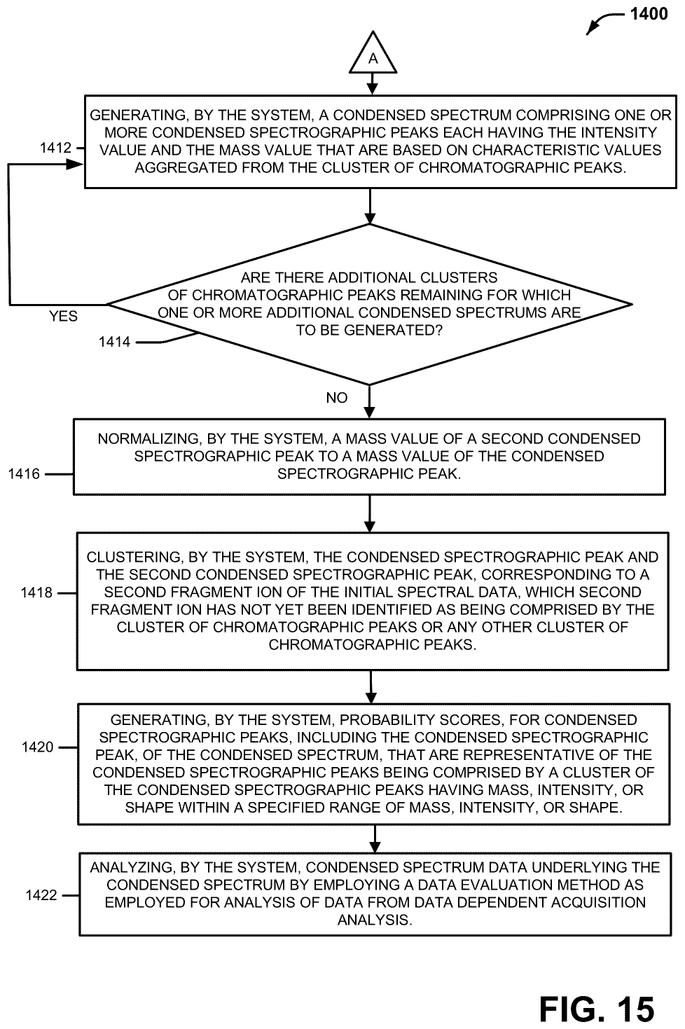

As a summary of the above-described components and/or functions thereof, referring next to FIGS. 14 and 15, illustrated is a flow diagram of an example, non-limiting method 1400 that can facilitate a process for chromatography data comparison and eluted analyte identification, in accordance with one or more example embodiments described herein, such as the non-limiting system 600 of FIG. 6. While the non-limiting method 1400 is described relative to the non-limiting system 600 of FIG. 6, the non-limiting method 1400 can be applicable also to other systems described herein, such as the non-limiting system of FIG. 7. Repetitive description of like elements and/or processes employed in respective embodiments is omitted for sake of brevity.

At 1402, the non-limiting method 1400 can comprise identifying, by a system (e.g., identifying component 610) a cluster (e.g., cluster 633) of chromatographic peaks (e.g., chromatographic peaks 634), corresponding to fragment ions (e.g., fragment ions 636), of initial measurement data (e.g., initial measurement data 632) obtained by data independent acquisition.

At 1403, the non-limiting method 1400 can comprise determining, by the system (e.g., condensed spectrum generating component 614, processor 606 and/or analytical model 694) to proceed with characteristic value use, pattern recognition, or both. If characteristic values are used, the non-limiting method 1400 can proceed to step 1404. If pattern recognition, the non-limiting method 1400 can proceed to step 1406. If both, the non-limiting method 1400 can proceed both to step 1404 and to step 1406.

At 1404, the non-limiting method 1400 can comprise identifying, by the system (e.g., clustering component 612), a group of chromatographic peaks, of the initial measurement data, having characteristic values within a specified range of characteristic values under the peaks, and identifies the group of chromatographic peaks as the cluster of chromatographic peaks.

At 1406, the non-limiting method 1400 can comprise identifying, by the system (e.g., clustering component 612), a group of chromatographic peaks, of the initial measurement data, by employing a pattern recognition process (e.g., pattern recognition process 642) on a graphical representation (e.g., graphical representation 700 and/or 800) of the initial measurement data based on specified intensity, retention time or mass ranges, and identifies the group of chromatographic peaks as the cluster of chromatographic peaks.

At 1408, the non-limiting method 1400 can comprise generating, by the system (e.g., condensed spectrum generating component 614), an intensity value (e.g., intensity value 684) based on the characteristic values (e.g., characteristic values 662) comprising an area under an ion trace or a peak intensity from an ion trace in the cluster of chromatographic peaks.

At 1410, the non-limiting method 1400 can comprise generating, by the system (e.g., condensed spectrum generating component 614), a mass value (e.g., mass value 686) based on the characteristic values (e.g., characteristic values 662) comprising a mean, average, or weighted-average mass from an ion trace of the cluster of chromatographic peaks.

At 1412, the non-limiting method 1400 can comprise generating, by the system (e.g., condensed spectrum generating component 614), a condensed spectrum (e.g., condensed spectrum 680) comprising one or more condensed spectrographic peaks (e.g., condensed spectrographic peak 660) each having the intensity value and the mass value that are based on characteristic values aggregated from the cluster of chromatographic peaks.

At 1414, the non-limiting method 1400 can comprise determining, by the system, (e.g., evaluating component 620), whether additional clusters of chromatographic peaks remain for which one or more additional condensed spectrums are to be generated. If not, the non-limiting method 1400 can proceed to step 1416. If yes, the non-limiting method 1400 can proceed back to step 1412.

At 1416, the non-limiting method 1400 can comprise normalizing, by the system (e.g., modifying component 614), a mass value of a second condensed spectrographic peak to a mass value of the condensed spectrographic peak.

At 1418, the non-limiting method 1400 can comprise clustering, by the system (e.g., modifying component 614), the condensed spectrographic peak and the second condensed spectrographic peak, corresponding to a second fragment ion of the initial spectral data, which second fragment ion has not yet been identified as being comprised by the cluster of chromatographic peaks or any other cluster of chromatographic peaks.

At 1420, the non-limiting method 1400 can comprise generating, by the system (e.g., enriching component 616), probability scores (e.g., probability scores 670), for condensed spectrographic peaks, including the condensed spectrographic peak, of the condensed spectrum, that are representative of the condensed spectrographic peaks being comprised by a cluster of the condensed spectrographic peaks having mass, intensity, or shape within a specified range of mass, intensity, or shape.

At 1422, the non-limiting method 1400 can comprise analyzing, by the system (e.g., evaluating component 620), condensed spectrum data (e.g., condensed spectrum data 682) underlying the condensed spectrum by employing a data evaluation method as employed for analysis of data from data dependent acquisition analysis.

### Additional Summary

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, embodiments described herein relate to analysis of spectrometry data. A computer-implemented method, for improving data analysis and data storage processes, can comprise identifying, by a system operatively coupled to a processor, a cluster of chromatographic peaks, corresponding to fragment ions, of initial measurement data obtained by data independent acquisition, and generating, by the system, a condensed spectrum comprising one or more condensed spectrographic peaks each having an intensity value and a mass value that are based on characteristic values aggregated from the cluster of chromatographic peaks.

The one or more example embodiments described herein can be implemented within, in connection with and/or coupled to a scientific measurement instrument, such as a spectrometry instrument.

Indeed, in view of the one or more example embodiments described herein, a practical application of the one or more systems, computer-implemented methods and/or computer program products described herein can be an ability to reduce complexity of analysis of exhaustive data acquired by a data independent acquisition process. That is, analysis can be applied selectively to data acquired without such selectivity. As compared to existing frameworks that cannot provide these abilities, this can reduce complexity of processing for analyzing resulting data, including time, power and/or labor employed. These are useful and practical applications of computers and/or analytical models, thus providing enhanced (e.g., improved and/or optimized) analyte analysis. Overall, such tools can constitute a concrete and tangible technical improvement in the fields of material analysis, and more particularly in analysis of scientific measurement instrument output, such as including, but not limited to, the field of spectrometry.

Furthermore, one or more example embodiments described herein can be employed in a real-world system based on the disclosed teachings. For example, one or more embodiments described herein can indirectly employ the resulting pseudo-DDA data (e.g., DDA-like data) to identify target peaks of target analytes relative to/using corresponding data generated from the related chromatographic traces. The embodiments disclosed herein thus can provide improvements to scientific instrument technology (e.g., improvements in the computer technology supporting such scientific instruments, among other improvements).

Moreover, the one or more example embodiments described herein can achieve a level of scale of operation. For example, spectrometry data corresponding to two or more compounds can be evaluated at least partially in parallel with one another relative to same and/or different instruments, columns, etc.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more example embodiments described herein can be, in one or more cases, inherently and/or inextricably tied to computer technology and cannot be implemented outside of a computing environment. For example, one or more processes performed by one or more example embodiments described herein can more efficiently, and even more feasibly, provide program and/or program instruction execution, such as relative to measurement instrument output analysis (e.g., measurement instrument use for material analysis), as compared to existing systems and/or techniques for addressing analysis of data independent acquisition-originating data. Systems, computer-implemented methods and/or computer program products providing performance of these processes are of great utility in the fields of material analysis and cannot be equally practicably implemented in a sensible way outside of a computing environment.

One or more example embodiments described herein can employ hardware and/or software to solve problems that are highly technical, that are not abstract, and that cannot be performed as a set of mental acts by a human. For example, a human, or even thousands of humans, cannot efficiently, accurately and/or effectively analyze computer data/metadata (e.g., defining spectrometry data and/or chromatography data) defining eluted analyte conductivity vs. elution time analyzed, and/or defining mass-to-charge ration vs. retention time, at one or more measurement instruments, and/or generate a digital display visual of quantified similarities and/or differences between datasets, as the one or more example embodiments described herein can provide this process. Moreover, neither can the human mind nor a human with pen and paper conduct one or more of these processes, as conducted by one or more example embodiments described herein.

In one or more example embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more example embodiments described herein and/or components thereof can be employed to solve new problems that arise through advancements in technologies mentioned above, employment of quantum computing systems, cloud computing systems, computer architecture and/or another technology.

One or more example embodiments described herein can be fully operational towards performing one or more other functions (e.g., fully powered on, fully executed and/or another function) while also performing one or more of the one or more operations described herein.

To provide additional summary, a listing of embodiments and features thereof is next provided.

A system, comprising: a memory that stores computer executable components; and a processor that executes the computer executable components stored in the memory, wherein the computer executable components comprise: an identifying component that identifies a cluster of chromatographic peaks, corresponding to fragment ions, of initial measurement data obtained by data independent acquisition; and a condensed spectrum generating component that generates a condensed spectrum comprising one or more condensed spectrographic peaks each having an intensity value and a mass value that are based on characteristic values aggregated from the cluster of chromatographic peaks.

The system of the preceding paragraph, wherein the condensed spectrum generating component generates the intensity value based on the characteristic values comprising an area under an ion trace or a peak intensity from an ion trace in the cluster of chromatographic peaks.

The system of any preceding paragraph, wherein the condensed spectrum generating component generates the mass value based on the characteristic values comprising a mean, average, or weighted-average mass from an ion trace of the cluster of chromatographic peaks.

The system of any preceding paragraph, wherein the condensed spectrum generating component generates a condensed spectrum retention time as a mean, median, weighted average or expected value of retention times of ion truces in the cluster.

The system of any preceding paragraph, wherein the computer executable components further comprise: an evaluating component that analyzes condensed spectrum data underlying the condensed spectrum by employing a data evaluation method as employed for analysis of data from data dependent acquisition analysis.

The system of any preceding paragraph, wherein the identifying component determines a precursor mass or precursor mass range.

The system of any preceding paragraph, wherein the identifying component determines the precursor mass or precursor mass range from a mass isolation window corresponding to the data independent acquisition, from identifying or correlating a corresponding one or more precursor ions observed within the data independent acquisition mass isolation window in a non-fragmenting mass analysis, from precursor ions identified by analysis of the data independent analysis mass spectrum.

The system of any preceding paragraph, wherein the data evaluation method employs precursor ion information.

The system of any preceding paragraph, wherein the computer executable components further comprise: a clustering component that identifies a group of chromatographic peaks, of the initial measurement data, having characteristic values within a specified range of characteristic values under the peaks, and identifies the group of chromatographic peaks as the cluster of chromatographic peaks.

The system of any preceding paragraph, wherein the computer executable components further comprise: a clustering component that identifies a group of chromatographic peaks, of the initial measurement data, by employing a pattern recognition process on a graphical representation of the initial measurement data based on specified intensity, retention time or mass ranges, and identifies the group of chromatographic peaks as the cluster of chromatographic peaks.

The system of any preceding paragraph, wherein the computer executable components further comprise: a modifying component that clusters the condensed spectrographic peak and a second condensed spectrographic peak, corresponding to a second fragment ion of the initial spectral data, which second fragment ion has not yet been identified as being comprised by the cluster of chromatographic peaks or any other cluster of chromatographic peaks, wherein the clustering is performed by normalizing a mass value of the second condensed spectrographic peak to a mass value of the condensed spectrographic peak.

The system of any preceding paragraph, wherein the computer executable components further comprise: an enriching component that generates probability scores, for condensed spectrographic peaks, including the condensed spectrographic peak, of the condensed spectrum, that are representative of the condensed spectrographic peaks being comprised by a cluster of the condensed spectrographic peaks having mass, intensity, or shape within a specified range of mass, intensity, or shape.

The system of any preceding paragraph, wherein the condensed spectrum is stored as condensed mass spectrometry data.

The system of any preceding paragraph, wherein the condensed spectrum is generated in real time in parallel to the acquisition.

The system of any preceding paragraph, wherein the identifying component identifies the cluster of chromatographic peaks of the initial measurement data obtained by data independent acquisition in parallel with the pseudo-spectrum generating component generating the pseudo-spectrum.

A computer-implemented method, comprising: identifying, by a system operatively coupled to a processor, a cluster of chromatographic peaks, corresponding to fragment ions, of initial measurement data obtained by data independent acquisition; and generating, by the system, a condensed spectrum comprising one or more condensed spectrographic peaks each having an intensity value and a mass value that are based on characteristic values aggregated from the cluster of chromatographic peaks.

The computer-implemented method of the preceding paragraph, further comprising: generating, by the system, the intensity value based on the characteristic values comprising an area under an ion trace or a peak intensity from an ion trace in the cluster of chromatographic peaks.

The computer-implemented method of any preceding paragraph, further comprising: generating, by the system, the mass value based on the characteristic values comprising a mean, average, or weighted-average mass from an ion trace of the cluster of chromatographic peaks.

The computer-implemented method of any preceding paragraph, further comprising: analyzing, by the system, condensed spectrum data underlying the condensed spectrum by employing a data evaluation method as employed for analysis of data from data dependent acquisition analysis.

The computer-implemented method of any preceding paragraph, further comprising: clustering, by the system, the condensed spectrographic peak and a second condensed spectrographic peak, corresponding to a second fragment ion of the initial spectral data, which second fragment ion has not yet been identified as being comprised by the cluster of chromatographic peaks or any other cluster of chromatographic peaks, wherein the clustering comprising normalizing, by the system, a mass value of the second condensed spectrographic peak to a mass value of the condensed spectrographic peak.

The computer-implemented method of any preceding paragraph, further comprising: identifying, by the system, a group of chromatographic peaks, of the initial measurement data, having characteristic values within a specified range of characteristic values under the peaks, and identifies the group of chromatographic peaks as the cluster of chromatographic peaks; or identifying, by the system, a group of chromatographic peaks, of the initial measurement data, by employing a pattern recognition process on a graphical representation of the initial measurement data based on specified intensity, retention time or mass ranges, and identifies the group of chromatographic peaks as the cluster of chromatographic peaks.

The computer-implemented method of any preceding paragraph, further comprising: generating, by the system, probability scores, for condensed spectrographic peaks, including the condensed spectrographic peak, of the condensed spectrum, that are representative of the condensed spectrographic peaks being comprised by a cluster of the condensed spectrographic peaks having mass, intensity, or shape within a specified range of mass, intensity, or shape.

A computer program product facilitating a process for improving data analysis and data storage processes, the computer program product comprising a computer readable storage medium having program instructions embodied therewith, and the program instructions executable by a processor to cause the processor to: identify, by the processor, a cluster of chromatographic peaks, corresponding to fragment ions, of initial measurement data obtained by data independent acquisition; and generate, by the processor, a condensed spectrum comprising one or more condensed spectrographic peaks each having an intensity value and a mass value that are based on characteristic values aggregated from the cluster of chromatographic peaks.

The computer program product of the preceding paragraph, wherein the program instructions are further executable by the processor to cause the processor to: generate, by the processor, the intensity value based on the characteristic values comprising an area under an ion trace or a peak intensity from an ion trace in the cluster of chromatographic peaks.

The computer program product of any preceding paragraph, wherein the program instructions are further executable by the processor to cause the processor to: generate, by the processor, the mass value based on the characteristic values comprising a mean, average, or weighted-average mass from an ion trace of the cluster of chromatographic peaks.

The computer program product of any preceding paragraph, wherein the program instructions are further executable by the processor to cause the processor to: analyze, by the processor, condensed spectrum data underlying the condensed spectrum by employing a data evaluation method as employed for analysis of data from data dependent acquisition analysis.

The computer program product of any preceding paragraph, wherein the program instructions are further executable by the processor to cause the processor to: cluster, by the processor, the condensed spectrographic peak and a second condensed spectrographic peak, corresponding to a second fragment ion of the initial spectral data, which second fragment ion has not yet been identified as being comprised by the cluster of chromatographic peaks or any other cluster of chromatographic peaks, wherein the clustering comprising normalizing, by the processor, a mass value of the second condensed spectrographic peak to a mass value of the condensed spectrographic peak.

The computer program product of any preceding paragraph, wherein the program instructions are further executable by the processor to cause the processor to: identify, by the processor, a group of chromatographic peaks, of the initial measurement data, having characteristic values within a specified range of characteristic values under the peaks, and identifies the group of chromatographic peaks as the cluster of chromatographic peaks; or identify, by the processor, a group of chromatographic peaks, of the initial measurement data, by employing a pattern recognition process on a graphical representation of the initial measurement data based on specified intensity, retention time or mass ranges, and identifies the group of chromatographic peaks as the cluster of chromatographic peaks.

The computer program product of any preceding paragraph, wherein the program instructions are further executable by the processor to cause the processor to: generate, by the processor, probability scores, for condensed spectrographic peaks, including the condensed spectrographic peak, of the condensed spectrum, that are representative of the condensed spectrographic peaks being comprised by a cluster of the condensed spectrographic peaks having mass, intensity, or shape within a specified range of mass, intensity, or shape.

### Example Operating Environment

FIG. 16 is a schematic block diagram of an operating environment 1600 with which the described subject matter can interact. The operating environment 1600 comprises one or more remote component(s) 1610. The remote component(s) 1610 can be hardware and/or software (e.g., threads, processes, computing devices). In one or more example embodiments, remote component(s) 1610 can be a distributed computer system, connected to a local automatic scaling component and/or programs that use the resources of a distributed computer system, via communication framework 1640. Communication framework 1640 can comprise wired network devices, wireless network devices, mobile devices, wearable devices, radio access network devices, gateway devices, femtocell devices, servers, etc.

The operating environment 1600 also comprises one or more local component(s) 1620. The local component(s) 1620 can be hardware and/or software (e.g., threads, processes, computing devices). In one or more example embodiments, local component(s) 1620 can comprise an automatic scaling component and/or programs that communicate/use the remote resources 1610 and 1620, etc., connected to a remotely located distributed computing system via communication framework 1640.

One possible communication between a remote component(s) 1610 and a local component(s) 1620 can be in the form of a data packet adapted to be transmitted between two or more computer processes. Another possible communication between a remote component(s) 1610 and a local component(s) 1620 can be in the form of circuit-switched data adapted to be transmitted between two or more computer processes in radio time slots. The operating environment 1600 comprises a communication framework 1640 that can be employed to facilitate communications between the remote component(s) 1610 and the local component(s) 1620, and can comprise an air interface, e.g., interface of a UMTS network, via an LTE network, etc. Remote component(s) 1610 can be operably connected to one or more remote data store(s) 1650, such as a hard drive, solid state drive, subscriber identity module (SIM) card, electronic SIM (eSIM), device memory, etc., that can be employed to store information on the remote component(s) 1610 side of communication framework 1640. Similarly, local component(s) 1620 can be operably connected to one or more local data store(s) 1630, that can be employed to store information on the local component(s) 1620 side of communication framework 1640.

### Example Computing Environment

In order to provide additional context for various embodiments described herein, FIG. 17 and the following discussion are intended to provide a brief, general description of a suitable computing environment 1700 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform tasks or implement abstract data types. Moreover, the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Referring still to FIG. 17, the example computing environment 1700 which can implement one or more example embodiments described herein includes a computer 1702, the computer 1702 including a processing unit 1704, a system memory 1706 and a system bus 1708. The system bus 1708 couples system components including, but not limited to, the system memory 1706 to the processing unit 1704. The processing unit 1704 can be any of various commercially available processors. Dual microprocessors and other multi-processor architectures can also be employed as the processing unit 1704.

The system bus 1708 can be any of several types of bus structure that can further interconnect to a memory bus (with or without a memory controller), a peripheral bus, and a local bus using any of a variety of commercially available bus architectures. The system memory 1706 includes ROM 1710 and RAM 1712. A basic input/output system (BIOS) can be stored in a non-volatile memory such as ROM, erasable programmable read only memory (EPROM), EEPROM, which BIOS contains the basic routines that help to transfer information between elements within the computer 1702, such as during startup. The RAM 1712 can also include a high-speed RAM such as static RAM for caching data.

The computer 1702 further includes an internal hard disk drive (HDD) 1714 (e.g., EIDE, SATA), and can include one or more external storage devices 1716 (e.g., a magnetic floppy disk drive (FDD) 1716, a memory stick or flash drive reader, a memory card reader, etc.). While the internal HDD 1714 is illustrated as located within the computer 1702, the internal HDD 1714 can also be configured for external use in a suitable chassis (not shown). Additionally, while not shown in computing environment 1700, a solid-state drive (SSD) could be used in addition to, or in place of, an HDD 1714.

Other internal or external storage can include at least one other storage device 1720 with storage media 1722 (e.g., a solid-state storage device, a nonvolatile memory device, and/or an optical disk drive that can read or write from removable media such as a CD-ROM disc, a DVD, a BD, etc.). The external storage 1716 can be facilitated by a network virtual machine. The HDD 1714, external storage device 1716 and storage device (e.g., drive) 1720 can be connected to the system bus 1708 by an HDD interface 1724, an external storage interface 1726 and a drive interface 1728, respectively.

The drives and their associated computer-readable storage media provide nonvolatile storage of data, data structures, computer-executable instructions, and so forth. For the computer 1702, the drives and storage media accommodate the storage of any data in a suitable digital format. Although the description of computer-readable storage media above refers to respective types of storage devices, other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1712, including an operating system 1730, one or more application programs 1732, other program modules 1734 and program data 1736. All or portions of the operating system, applications, modules, and/or data can also be cached in the RAM 1712. The systems and methods described herein can be implemented utilizing various commercially available operating systems or combinations of operating systems.

Computer 1702 can optionally comprise emulation technologies. For example, a hypervisor (not shown) or other intermediary can emulate a hardware environment for operating system 1730, and the emulated hardware can optionally be different from the hardware illustrated in FIG. 17. In such an embodiment, operating system 1730 can comprise one virtual machine (VM) of multiple VMs hosted at computer 1702. Furthermore, operating system 1730 can provide runtime environments, such as the Java runtime environment or the .NET framework, for applications 1732. Runtime environments are consistent execution environments that allow applications 1732 to run on any operating system that includes the runtime environment. Similarly, operating system 1730 can support containers, and applications 1732 can be in the form of containers, which are lightweight, standalone, executable packages of software that include, e.g., code, runtime, system tools, system libraries and settings for an application.

Further, computer 1702 can be enabled with a security module, such as a trusted processing module (TPM). For instance, with a TPM, boot components hash next in time boot components and wait for a match of results to secured values, before loading a next boot component. This process can take place at any layer in the code execution stack of computer 1702, e.g., applied at the application execution level or at the operating system (OS) kernel level, thereby enabling security at any level of code execution.

A user entity can enter commands and information into the computer 1702 through one or more wired/wireless input devices, e.g., a keyboard 1738, a touch screen 1740, and a pointing device, such as a mouse 1742. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera, a gesture sensor input device, a vision movement sensor input device, an emotion or facial detection device, a biometric input device, e.g., fingerprint or iris scanner, or the like. These and other input devices are often connected to the processing unit 1704 through an input device interface 1744 that can be coupled to the system bus 1708, but can be connected by other interfaces, such as a parallel port, an IEEE 1394 serial port, a game port, a USB port, an IR interface, a BLUETOOTH® interface, etc.

A monitor 1746 or other type of display device can also be connected to the system bus 1708 via an interface, such as a video adapter 1748. In addition to the monitor 1746, a computer typically includes other peripheral output devices (not shown), such as speakers, printers, etc.

The computer 1702 can operate in a networked environment using logical connections via wired and/or wireless communications to one or more remote computers, such as a remote computer 1750. The remote computer 1750 can be a workstation, a server computer, a router, a personal computer, portable computer, microprocessor-based entertainment appliance, a peer device or other common network node, and typically includes many or all of the elements described relative to the computer 1702, although, for purposes of brevity, only a memory/storage device 1752 is illustrated. The logical connections depicted include wired/wireless connectivity to a local area network (LAN) 1754 and/or larger networks, e.g., a wide area network (WAN) 1756. Such LAN and WAN networking environments are commonplace in offices and companies, and facilitate enterprise-wide computer networks, such as intranets, all of which can connect to a global communications network, e.g., the Internet.

When used in a LAN networking environment, the computer 1702 can be connected to the local network 1754 through a wired and/or wireless communication network interface or adapter 1758. The adapter 1758 can facilitate wired or wireless communication to the LAN 1754, which can also include a wireless access point (AP) disposed thereon for communicating with the adapter 1758 in a wireless mode.

When used in a WAN networking environment, the computer 1702 can include a modem 1760 or can be connected to a communications server on the WAN 1756 via other means for establishing communications over the WAN 1756, such as by way of the Internet. The modem 1760, which can be internal or external and a wired or wireless device, can be connected to the system bus 1708 via the input device interface 1744. In a networked environment, program modules depicted relative to the computer 1702 or portions thereof, can be stored in the remote memory/storage device 1752. The network connections shown are example and other means of establishing a communications link between the computers can be used.

When used in either a LAN or WAN networking environment, the computer 1702 can access cloud storage systems or other network-based storage systems in addition to, or in place of, external storage devices 1716 as described above. Generally, a connection between the computer 1702 and a cloud storage system can be established over a LAN 1754 or WAN 1756 e.g., by the adapter 1758 or modem 1760, respectively. Upon connecting the computer 1702 to an associated cloud storage system, the external storage interface 1726 can, with the aid of the adapter 1758 and/or modem 1760, manage storage provided by the cloud storage system as it would other types of external storage. For instance, the external storage interface 1726 can be configured to provide access to cloud storage sources as if those sources were physically connected to the computer 1702.

The computer 1702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a defined structure as with an existing network or simply an ad hoc communication between at least two devices.

### Additional Information

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more example embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more example embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more example embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more example embodiments described herein.

Aspects of the one or more example embodiments described herein are described with reference to flowchart illustrations and/or block diagrams of methods, apparatus (systems), and computer program products according to one or more example embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more example embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more example embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more example embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more example embodiments, but one of ordinary skill in the art can recognize that many further combinations and/or permutations of the one or more example embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments can use the phrases “an embodiment,” “various embodiments,” “one or more example embodiments” and/or “some embodiments,” each of which can refer to one or more of the same or different embodiments.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an identifying component that identifies a cluster of chromatographic peaks, corresponding to fragment ions, of initial measurement data obtained by data independent acquisition; and
a condensed spectrum generating component that generates a condensed spectrum comprising one or more condensed spectrographic peaks each having an intensity value and a mass value that are based on characteristic values aggregated from the cluster of chromatographic peaks.

2. The system of claim 1, wherein the characteristic values comprise one or more of mass, intensity/area, retention time, S/N, flags, ion time, charge state, instrument, identified clusters, isotopic clusters or ion mobility information.

3. The system of claim 1, wherein the condensed spectrum generating component generates the intensity value based on the characteristic values comprising an area under an ion trace or a peak intensity from an ion trace in the cluster of chromatographic peaks.

4. The system of claim 1, wherein the condensed spectrum generating component generates the mass value based on the characteristic values comprising a mean, average, or weighted-average mass from an ion trace of the cluster of chromatographic peaks.

5. The system of claim 1, wherein the condensed spectrum generating component generates a condensed spectrum retention time as a mean, median, weighted average or expected value of retention times of ion truces in the cluster.

6. The system of claim 1, wherein the computer executable components further comprise:
an evaluating component that analyzes condensed spectrum data underlying the condensed spectrum by employing a data evaluation method as employed for analysis of data from data dependent acquisition analysis.

7. The system of claim 6, wherein the data evaluation method does not employ data defining a precursor ion corresponding to the fragment ions.

8. The system of claim 6, wherein the identifying component determines a precursor mass or precursor mass range.

9. The system of claim 8, wherein the identifying component determines the precursor mass or precursor mass range from a mass isolation window corresponding to the data independent acquisition, from identifying or correlating a corresponding one or more precursor ions observed within the data independent acquisition mass isolation window in a non-fragmenting mass analysis, from precursor ions identified by analysis of the data independent analysis mass spectrum.

10. The system of claim 6, wherein the data evaluation method employs precursor ion information.

11. The system of claim 1, wherein the computer executable components further comprise:
a clustering component that identifies a group of chromatographic peaks, of the initial measurement data, having characteristic values within a specified range of characteristic values under the peaks, and identifies the group of chromatographic peaks as the cluster of chromatographic peaks.

12. The system of claim 1, wherein the computer executable components further comprise:
a clustering component that identifies a group of chromatographic peaks, of the initial measurement data, by employing a pattern recognition process on a graphical representation of the initial measurement data based on specified intensity, retention time or mass ranges, and identifies the group of chromatographic peaks as the cluster of chromatographic peaks.

13. The system of claim 1, wherein the computer executable components further comprise:
a modifying component that clusters the condensed spectrographic peak and a second condensed spectrographic peak, corresponding to a second fragment ion of the initial spectral data, which second fragment ion has not yet been identified as being comprised by the cluster of chromatographic peaks or any other cluster of chromatographic peaks,
wherein the clustering is performed by normalizing a mass value of the second condensed spectrographic peak to a mass value of the condensed spectrographic peak.

14. The system of claim 1, wherein the computer executable components further comprise:
an enriching component that generates probability scores, for condensed spectrographic peaks, including the condensed spectrographic peak, of the condensed spectrum, that are representative of the condensed spectrographic peaks being comprised by a cluster of the condensed spectrographic peaks having mass, intensity, or shape within a specified range of mass, intensity, or shape.

15. The system of claim 1, wherein the condensed spectrum is stored as condensed mass spectrometry data.

16. The system of claim 1, wherein the identifying component identifies the cluster of chromatographic peaks of the initial measurement data obtained by data independent acquisition in parallel with the condensed spectrum generating component generating the condensed spectrum.

17. A computer-implemented method, comprising:
identifying, by a system operatively coupled to a processor, a cluster of chromatographic peaks, corresponding to fragment ions, of initial measurement data obtained by data independent acquisition; and
generating, by the system, a condensed spectrum comprising one or more condensed spectrographic peaks each having an intensity value and a mass value that are based on characteristic values aggregated from the cluster of chromatographic peaks.

18. The computer-implemented method of claim 17, further comprising:
generating, by the system, the intensity value based on the characteristic values comprising an area under an ion trace or a peak intensity from an ion trace in the cluster of chromatographic peaks, the mass value based on the characteristic values comprising a mean, average, or weighted-average mass from an ion trace of the cluster of chromatographic peaks, and a condensed spectrum retention time as a mean, median, weighted average or expected value of retention times of ion truces in the cluster.

19. A computer program product facilitating a process for improving data analysis and data storage processes, the computer program product comprising a computer readable storage medium having program instructions embodied therewith, and the program instructions executable by a processor to cause the processor to:
identify, by the processor, a cluster of chromatographic peaks, corresponding to fragment ions, of initial measurement data obtained by data independent acquisition; and
generate, by the processor, a condensed spectrum comprising one or more condensed spectrographic peaks each having an intensity value and a mass value that are based on characteristic values aggregated from the cluster of chromatographic peaks.

20. The computer program product of claim 19, wherein the program instructions are further executable by the processor to cause the processor to:
analyze, by the processor, condensed spectrum data underlying the condensed spectrum by employing a data evaluation method as employed for analysis of data from data dependent acquisition analysis.
